(19) United States
(12) Patent Application Publication
(10) Pub. No.: US 2026/0138022 A1
(43) Pub. Date: May 21, 2026

(54) Virtual World-Based Interaction Method and Apparatus, Device, Medium, and Program Product

(71) Applicant: Tencent Technology (Shenzhen) Company Limited, Shenzhen (CN)

(72) Inventors: Nu ZHANG, Shenzhen (CN); Qi Sang, Shenzhen (CN); Pengcheng Xu, Shenzhen (CN)

(73) Assignee: Tencent Technology (Shenzhen) Company Limited, Shenzhen (CN)

(21) Appl. No.: 19/447,477

(22) Filed: Jan. 13, 2026

Related U.S. Application Data
(63) Continuation of application No. PCT/CN2024/106422, filed on Jul. 19, 2024.

(30) Foreign Application Priority Data
Sep. 22, 2023 (CN) 202311245978.X

(51) Int. Cl. A63F 13/56; A63F 13/52; A63F 13/67

(52) U.S. Cl. CPC A63F 13/56; A63F 13/52; A63F 13/67

(57) ABSTRACT

A virtual world-based interaction method, includes: displaying at least two terrain platforms located in a virtual world, the at least two terrain platforms being platforms for supporting at least two virtual characters, and at least one of the at least two terrain platforms being a mobile platform (320); controlling, in response to a movement control operation on the mobile platform, the mobile platform to be moved in the virtual world, to change a terrain formed by the at least two terrain platforms (340); and controlling, in response to a character control operation on a first virtual character, the first virtual character to interact with another virtual character in the at least two virtual characters on the terrain formed by the at least two terrain platforms (360).

### RELATED APPLICATION

This application is a continuation of and claims the benefit of priority to PCT Application No. PCT/CN2024/106422, filed July 19, 2024, and entitled INTERACTION METHOD AND APPARATUS BASED ON VIRTUAL WORLD, DEVICE, MEDIUM, AND PROGRAM PRODUCT, which is based on and claims the benefit of priority to Chinese Patent Application No. 202311245978.X, entitled "VIRTUAL WORLD-BASED INTERACTION METHOD AND APPARATUS, DEVICE, MEDIUM, AND PROGRAM PRODUCT", and filed on September 22, 2023. The above applications are incorporated herein by reference in their entireties.

### FIELD OF THE TECHNOLOGY

The present disclosure relates to the field of human-computer interaction, and in particular, to a virtual world-based interaction method and apparatus, a device, a medium, and a program product.

### BACKGROUND OF THE DISCLOSURE

In a virtual world-based network game, a plurality of players can simultaneously enter an instance for multiplayer battle.

In the related art, a terrain in a multiplayer battle scenario does not change during the entire battle. Alternatively, a player can change a terrain only by using some virtual props, for example, use some virtual props to generate some obstacles in the multiplayer battle scenario, so as to change the terrain in the multiplayer battle scenario through the obstacles.

However, in the related art, the player cannot autonomously change the terrain in the multiplayer battle scenario during the battle, causing monotonous online gaming.

### SUMMARY

The present disclosure provides a virtual world-based interaction method and apparatus, a device, a medium, and a program product. The technical solutions are as follows.

According to an aspect of the present disclosure, a virtual world-based interaction method is provided. The method is performed by a computer device and includes:

displaying at least two terrain platforms located in a virtual world, the at least two terrain platforms being platforms for supporting at least two virtual characters, and at least one of the at least two terrain platforms being a mobile platform;

controlling, in response to a movement control operation on the mobile platform, the mobile platform to be moved in the virtual world, to change a terrain formed by the at least two terrain platforms; and

controlling, in response to a character control operation on a first virtual character, the first virtual character to interact with another virtual character in the at least two virtual characters on the terrain formed by the at least two terrain platforms.

According to another aspect of the present disclosure, a virtual world-based interaction apparatus is provided. The apparatus includes:

a display module, configured to display at least two terrain platforms located in a virtual world, the at least two terrain platforms being platforms for supporting at least two virtual characters, and at least one of the at least two terrain platforms being a mobile platform; and

a control module, configured to control, in response to a movement control operation on the mobile platform, the mobile platform to be moved in the virtual world, to change a terrain formed by the at least two terrain platforms,

the control module being configured to control, in response to a character control operation on a first virtual character, the first virtual character to interact with another virtual character in the at least two virtual characters on the terrain formed by the at least two terrain platforms.

According to another aspect of the present disclosure, a computer device is provided, including a processor and a memory, the memory storing a computer program, the computer program being loaded and executed by the processor to implement the virtual world-based interaction method described above.

According to another aspect of the present disclosure, a computer-readable storage medium is provided, having a computer program stored therein, the computer program being loaded and executed by a processor to implement the virtual world-based interaction method described above.

According to another aspect of the present disclosure, a computer program product is provided, including computer instructions, the computer instructions being stored in a computer-readable storage medium, a processor reading the computer instructions from the computer-readable storage medium, and the processor loading and executing the computer instructions to implement the virtual world-based interaction method described above.

Beneficial effects brought by the technical solutions provided in embodiments of the present disclosure are at least as follows:

In the foregoing solutions, a game instance play method is designed. At least one terrain platform in the virtual world is set as a mobile platform, so that a player can move the mobile platform by performing the movement control operation, and the player can autonomously change a position of the terrain platform in the virtual world, to change a terrain in the virtual world. Further, the player can autonomously change a terrain in a multiplayer battle scenario during a battle, and take full advantage of a terrain change achieved through movement of the mobile platform in the virtual world, to deal with a combat mechanism in the virtual world, and explore fun of an instance combat in space with a high degree of freedom. In this way, a game mechanism is enriched, complexity and playability of the game are enhanced, and the player is more interested in the game.

### BRIEF DESCRIPTION OF THE DRAWINGS

FIG. 1 is an example structural block diagram of a computer system according to an exemplary embodiment.

FIG. 2 is an example schematic diagram of a virtual world-based interaction method according to an exemplary embodiment.

FIG. 3 is an example flowchart of a virtual world-based interaction method according to an exemplary embodiment.

FIG. 4 is an example flowchart of a virtual world-based interaction method according to an exemplary embodiment.

FIG. 5 is an example schematic diagram of a virtual world-based interaction method according to an exemplary embodiment.

FIG. 6 is an example schematic diagram of a virtual world-based interaction method according to an exemplary embodiment.

FIG. 7 is an example schematic diagram of a virtual world-based interaction method according to an exemplary embodiment.

FIG. 8 is an example schematic diagram of a virtual world-based interaction method according to an exemplary embodiment.

FIG. 9 is an example schematic diagram of a virtual world-based interaction method according to an exemplary embodiment.

FIG. 10 is an example schematic diagram of a virtual world-based interaction method according to an exemplary embodiment.

FIG. 11 is an example schematic diagram of a virtual world-based interaction method according to an exemplary embodiment.

FIG. 12 is an example schematic diagram of a virtual world-based interaction method according to an exemplary embodiment.

FIG. 13 is an example schematic diagram of a virtual world-based interaction method according to an exemplary embodiment.

FIG. 14 is an example schematic diagram of a virtual world-based interaction method according to an exemplary embodiment.

FIG. 15 is an example schematic diagram of a virtual world-based interaction method according to an exemplary embodiment.

FIG. 16 is an example flowchart of a virtual world-based interaction method according to an exemplary embodiment.

FIG. 17 is an example block diagram of a virtual world-based interaction apparatus according to an exemplary embodiment.

FIG. 18 is an example structural block diagram of a computer device according to an exemplary embodiment.

### DESCRIPTION OF EMBODIMENTS

To make objectives, technical solutions, and advantages of the present disclosure clearer, the following further describes implementations of the present disclosure in detail with reference to the accompanying drawings.

Exemplary embodiments are described in detail herein, and examples of the exemplary embodiments are shown in the accompanying drawings. When the following descriptions are made with reference to the accompanying drawings, unless indicated otherwise, same numbers in different accompanying drawings represent the same or similar elements. The implementations described in the following exemplary embodiments do not represent all implementations that are consistent with the present disclosure. On the contrary, the implementations are merely examples of apparatuses and methods that are described in detail in the appended claims and that are consistent with some aspects of the present disclosure.

The terms used in the present disclosure are for the purpose of describing specific embodiments only and are not intended to limit the present disclosure. The singular forms of "a" and "the" used in the present disclosure and the appended claims are intended to include the plural forms as well, unless otherwise specified in the context clearly. It is to be further understood that the term "and/or" used herein indicates and includes any or all possible combinations of one or more associated listed items.

Although the terms such as "first" and "second" may be used in the present disclosure to describe various information, the information shall not be limited to these terms. These terms are merely used to distinguish between information of the same type. For example, without departing from the scope of the present disclosure, a first parameter may also be referred to as a second parameter, and similarly, the second parameter may also be referred to as the first parameter. Depending on the context, for example, the term "if" used herein may be interpreted as "while", "when", or "in response to determining".

In the present disclosure, a prompt interface, a pop-up window, or voice prompt information may be displayed before user related data (for example, related information of a user account, permission information, operation information related to a permission obtaining operation, a movement control operation, and a character control operation) is collected and when the user related data is collected. The prompt interface, the pop-up window, or the voice prompt information is configured for prompting a user that the user related data is being collected currently, so that in the present disclosure, a related operation of obtaining the user related data starts to be performed only after a confirmation operation by the user on the prompt interface or the pop-up window is obtained. Otherwise (that is, when a confirmation operation by the user on the prompt interface or the pop-up window is not obtained), a related operation of obtaining the user related data ends, that is, the user related data is not obtained. In other words, all user data acquired in the present disclosure is acquired when the user agrees and authorizes, and acquisition, use, and processing of related user data need to comply with the relevant laws and standards of the relevant countries and regions.

First, terms in embodiments of the present disclosure are briefly introduced below.

Virtual world: The virtual world is a virtual world displayed (provided) by an application when run on a terminal. The virtual world may be a simulated world of a real world, or may be a semi-simulated semi-fictional three-dimensional world, or may be an entirely fictional three-dimensional world. The virtual world may be any one of a two-dimensional virtual world, a 2.5-dimensional virtual world, and a three-dimensional virtual world. In an embodiment, the virtual world is further configured for a virtual world battle between at least two virtual characters, and virtual resources available to the at least two virtual characters are provided in the virtual world. In an embodiment, the virtual world includes a lower left corner area and an upper right corner area that are symmetrical. Virtual characters on two opposing sides occupy the areas respectively.

Virtual character: The virtual character is a movable object in a virtual world. The movable object may be at least one of a virtual person, a virtual animal, and a cartoon person. In an embodiment, when the virtual world is a three-dimensional virtual world, the virtual character may be a three-dimensional virtual model. Each virtual character has a shape and a volume in the three-dimensional virtual world, and occupies some space in the three-dimensional virtual world. In an embodiment, the virtual character is a three-dimensional character constructed based on a three-dimensional human skeleton technology. The virtual character wears different skins to implement different appearances. In some implementations, the virtual character may alternatively be implemented by using a 2.5-dimensional model or a two-dimensional model. This is not limited in embodiments of the present disclosure.

In response to: "In response to" is configured for representing a condition or status on which one or more operations to be performed depend. When the condition or status is met, the one or more operations may be performed immediately or after a set delay. There is no limitation to a sequence of performing the plurality of operations unless explicitly stated.

Terrain platform: The terrain platform is a platform that supports a virtual character in a virtual world, in other words, the virtual character can stand on the terrain platform. Each terrain platform has a respective shape and size in a three-dimensional virtual world, and occupies some space in the three-dimensional virtual world.

For example, the terrain platform in this embodiment includes a mobile platform and a fixed platform. The fixed platform is a fixed terrain platform, and a position of the fixed platform is immovable. The mobile platform is a movable terrain platform, and a position of the mobile platform is movable. In this embodiment, when the mobile platform moves, a virtual object and a virtual character located on the mobile platform are moved together, similar to an elevator or a conveyor belt in a real scenario.

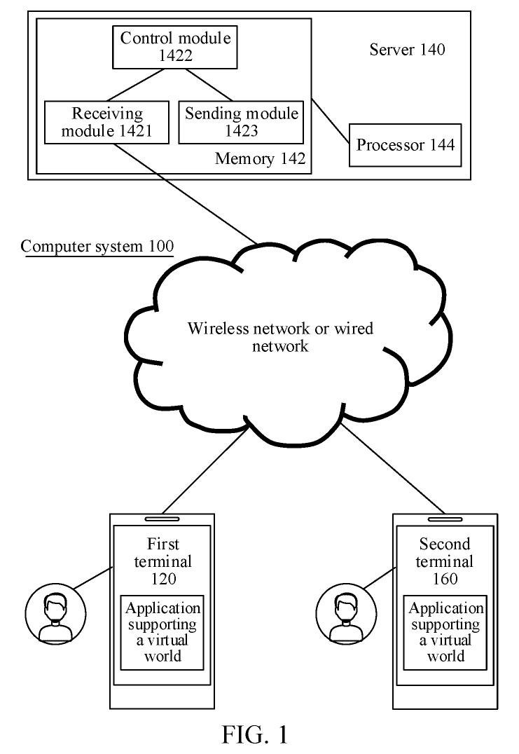

FIG. 1 is a structural block diagram of a computer system 100 according to an exemplary embodiment of the present disclosure. The computer system 100 may be a system architecture that implements a virtual world-based interaction method. The computer system 100 includes a first terminal 120, a server 140, and a second terminal 160.

An application supporting a virtual world is installed and run on the first terminal 120. For example, the application may be any one of an escape shooting game, a virtual reality (VR) application, an augmented reality (AR) program, a three-dimensional map program, a VR game, an AR game, a first-person shooting (FPS) game, a third-person shooting (TPS) game, a multiplayer online battle arena (MOBA) game, and a simulation game (SLG).

The first terminal 120 is a terminal used by a first user. The first user uses the first terminal 120 to control a first virtual character located in the virtual world. The control includes, but is not limited to, at least one of body posture adjustment, crawling, walking, running, cycling, jumping, driving, picking, shooting, attacking, throwing, and virtual building construction. The first user may use the first terminal 120 to interact with a non-player character (NPC) in the virtual world, or may use the first terminal 120 to control a mobile platform in the virtual world to move.

The first terminal 120 is connected to the server 140 through a wireless network or a wired network.

The server 140 may be an independent physical server, or may be a server cluster or a distributed system including a plurality of physical servers, or may be a cloud server that provides basic cloud computing services such as a cloud server that provides a cloud computing service, a cloud database, cloud computing, a cloud function, cloud storage, a network service, cloud communication, a middleware service, a domain name service, a security service, a content delivery network (CDN), big data, and an artificial intelligence platform. The server 140 includes at least one of one server, a plurality of servers, a cloud computing platform, and a virtualization center.

For example, the server 140 includes a processor 144 and a memory 142. The memory 142 further includes a receiving module 1421, a control module 1422, and a sending module 1423. The receiving module 1421 is configured to receive a request sent by a client, for example, a viewing request for viewing at least one of a quantity, locations, and attributes of opponent virtual characters, or a check request for determining whether a virtual character is located on the mobile platform. The control module 1422 is configured to control rendering of a virtual world picture. The sending module 1423 is configured to send a response to the client, for example, send at least one of the quantity, locations, and attribute values of the opponent virtual characters, or send, to the client, a check result of whether the virtual character is located on the mobile platform. The server 140 is configured to provide a backend service for an application of the first terminal 120 and an application of the second terminal 160.

In an embodiment, the server 140 is responsible for primary computing work, and the first terminal 120 and the second terminal 160 are responsible for secondary computing work. Alternatively, the server 140 is responsible for secondary computing work, and the first terminal 120 and the second terminal 160 are responsible for primary computing work. Alternatively, the server 140, the first terminal 120, and the second terminal 160 perform collaborative computing by using a distributed computing architecture among each other.

An application supporting a virtual world is installed and run on the second terminal 160. The application may be any one of an escape shooting game, a VR application program, an AR program, a three-dimensional map program, a VR game, an AR game, an FPS game, a TPS game, a MOBA game, and an SLG.

The second terminal 160 is a terminal used by a second user. The second user uses the second terminal 160 to control a second virtual character located in the virtual world. The control includes, but is not limited to, at least one of body posture adjustment, crawling, walking, running, cycling, jumping, driving, picking, shooting, attacking, throwing, and virtual building construction. The second user may use the second terminal 160 to interact with an NPC in the virtual world, or may use the second terminal 160 to control a mobile platform in the virtual world to move.

A virtual character controlled by the first user through the first terminal 120 and a virtual character controlled by the second user through the second terminal 160 are located at different positions in a same virtual world, in other words, the first user and the second user are in a same battle.

In an embodiment, the applications installed on the first terminal 120 and the second terminal 160 are the same, or the applications installed on the two terminals are a same type of applications in different control system platforms. Forms of the applications installed on the first terminal 120 and the second terminal 160 are not limited in this embodiment of the present disclosure, and include, but are not limited to, applications (Apps), mini programs, and the like installed on the first terminal 120 and the second terminal 160. The applications may alternatively be in a form of a web page. The first terminal 120 may be generally one of a plurality of terminals, and the second terminal 160 may be generally one of a plurality of terminals. In this embodiment, only the first terminal 120 and the second terminal 160 are used as an example for description. The first terminal 120 and the second terminal 160 are of a same or different device types. The device type includes at least one of a smartphone, a tablet computer, a wearable device, a personal computer (PC), an e-book reader, a digital player, a laptop portable computer, and a desktop computer. The following embodiment is described by using an example in which the terminal includes a smartphone.

A person skilled in the art may learn that there may be more or fewer terminals. For example, there may be only one terminal (that is, the user battles against artificial intelligence), or there may be eight terminals (1v1v1v1v1v1v1v1v1, a cyclic battle and elimination are performed between eight users, and a winner is finally picked), or there may be more terminals. The quantity and the device type of the terminals are not limited in embodiments of the present disclosure.

Embodiments of the present disclosure provide a virtual world-based interaction method, performed by a computer device. In an embodiment, the computer device may be the first terminal 120 or the second terminal 160 shown in FIG. 1. Applications supporting a virtual world are separately installed and run on the first terminal 120 and the second terminal 160.

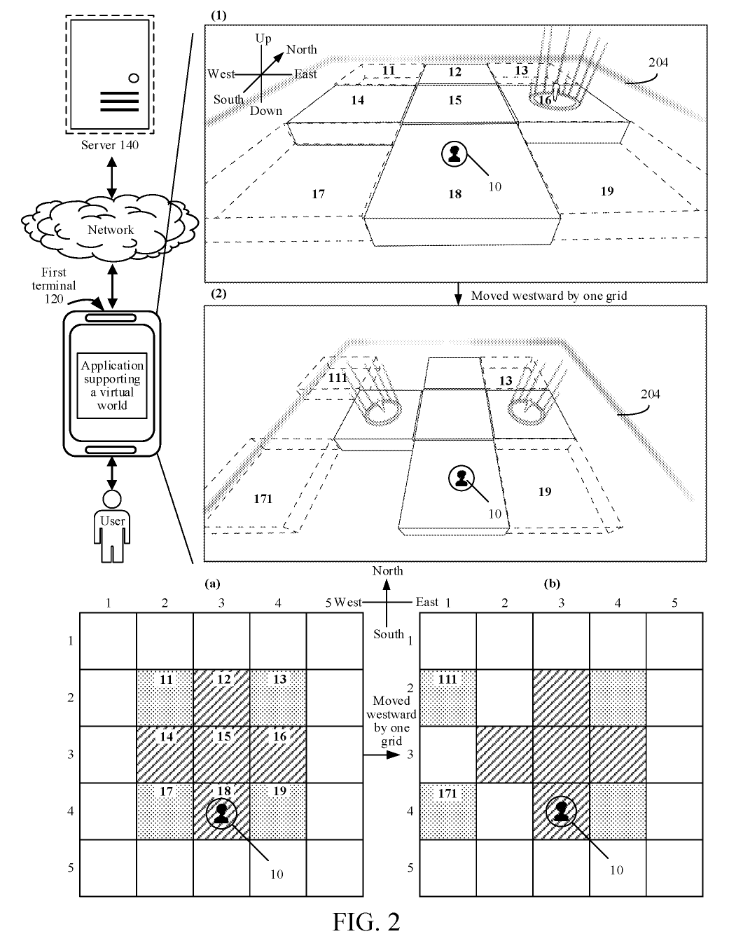

FIG. 2 is a schematic diagram of a virtual world-based interaction method according to an exemplary embodiment of the present disclosure. Operations are briefly described below by using an example in which the computer device is the first terminal 120.

1. The computer device displays at least two terrain platforms located in a virtual world, the at least two terrain platforms being platforms for supporting at least two virtual characters, and at least one of the at least two terrain platforms being a mobile platform.

As shown in a schematic diagram (1) and a top view (a) in FIG. 2, nine terrain platforms are disposed within a boundary line 204 of the virtual world, namely, a terrain platform 11, a terrain platform 12, a terrain platform 13, a terrain platform 14, a terrain platform 15, a terrain platform 16, a terrain platform 17, a terrain platform 18, and a terrain platform 19. The terrain platform 11, the terrain platform 13, the terrain platform 17, and the terrain platform 19 are mobile platforms, and are distributed at four corners. The terrain platform 12, the terrain platform 14, the terrain platform 15, the terrain platform 16, and the terrain platform 18 are fixed platforms, and are distributed in a cross shape. In some other embodiments, all the nine terrain platforms may be mobile platforms. A first virtual character 10 is a virtual character controlled by a first user through the first terminal 120, and the first virtual character 10 is located on the fixed platform 18. In this embodiment, the mobile platform may be set to move in at least two directions: east, west, south, north, up, and down.

2. The computer device controls, in response to a permission obtaining operation, the first virtual character to obtain a control permission for the mobile platform.

The control permission is a permission for controlling movement of the mobile platform, and may be specifically a permission for controlling the mobile platform to be moved in a direction. When the first virtual character 10 obtains the control permission for the mobile platform, the first user may control movement of the mobile platform by using the first virtual character 10.

3. The computer device controls, in response to a movement control operation on the mobile platform, the mobile platform to be moved in the virtual world, to change a terrain formed by the at least two terrain platforms.

For example, the control permission is a permission for controlling the mobile platform to be moved westward, and the movement control operation is to move the mobile platform westward by one grid. As shown in a schematic diagram (2) and the top view (a) in FIG. 2, the first terminal 120 controls the terrain platform 11, the terrain platform 13, the terrain platform 17, and the terrain platform 19 to move westward by one grid. After movement, the terrain platform 11 becomes a terrain platform 111, and the terrain platform 17 becomes a terrain platform 171. Because the terrain platform 13 and the terrain platform 19 are obstructed by the fixed platforms, the terrain platform 13 and the terrain platform 19 remain unchanged.

4. The computer device controls, in response to a character control operation on the first virtual character, the first virtual character to interact with another virtual character in the at least two virtual characters on the terrain formed by the at least two terrain platforms.

The first terminal 120 further controls, in response to the character control operation on the first virtual character 10, the first virtual character to interact with another virtual character in the at least two virtual characters on the terrain formed by the at least two terrain platforms. The interaction includes at least one of shooting, attacking, throwing, dialoguing, and battling.

In conclusion, in embodiments of the present disclosure, a game instance play method is designed. Movement control of the mobile platform in the virtual world is transferred to a player, so that the player can fully play an autonomous role. A plurality of players cooperate with each other, and a terrain change is achieved through movement of the mobile platform in the virtual world, to deal with a combat mechanism of an online game, and explore fun of an instance combat in space with a high degree of freedom. The game instance play method is an instance play method in which decryption and combat are combined, so that gaming mechanics are more diverse.

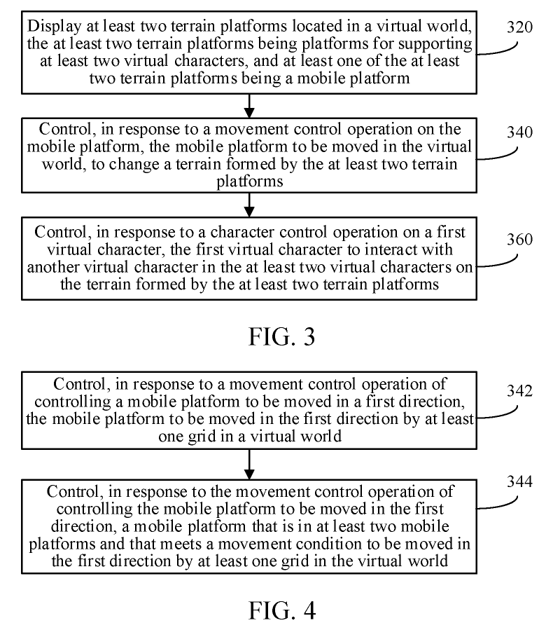

FIG. 3 is a flowchart of a virtual world-based interaction method according to an exemplary embodiment of the present disclosure. The method is applied to a computer device. The computer device may be the first terminal 120 or the second terminal 160 shown in FIG. 1. The method includes operation 320, operation 340, and operation 360.

Operation 320: Display at least two terrain platforms located in a virtual world, the at least two terrain platforms being platforms for supporting at least two virtual characters, and at least one of the at least two terrain platforms being a mobile platform.

The virtual world is three-dimensional virtual activity space provided in a running process of an application installed and run on the computer device, for a virtual character to perform various activities in the three-dimensional virtual activity space.

The terrain platform is a platform for supporting a virtual character in the virtual world.

In an embodiment, the virtual world includes at least two terrain platforms, that is, the at least two terrain platforms are configured for forming a terrain of the virtual world. Shapes of the at least two terrain platforms may be at least one of a rectangle, a square, a circle, and an irregular pattern. Shapes and volumes of different terrain platforms may be the same or different. This is not limited in this embodiment. In an initial state, the at least two terrain platforms in the virtual world are located on a same horizontal plane.

The mobile platform is a movable terrain platform.

In an embodiment, at least one of the at least two terrain platforms is a mobile platform. In the initial state, the mobile platform in the virtual world is located at an initial position that is preset. For example, the at least two terrain platforms in the virtual world include five fixed platforms and four mobile platforms. In the initial state, the five fixed platforms are distributed in a cross shape, and the four mobile platforms are distributed at four corners of the fixed platforms.

For example, the computer device displays an entrance to the virtual world, and the computer device displays, in response to a trigger operation on the entrance to the virtual world, at least two terrain platforms located in the virtual world. The trigger operation includes at least one of a tap operation, a double-tap operation, a long press operation, and a touch operation.

Operation 340: Control, in response to a movement control operation on the mobile platform, the mobile platform to be moved in the virtual world, to change a terrain formed by the at least two terrain platforms.

The movement control operation is an operation of controlling movement of the mobile platform, and may be specifically an operation of controlling the mobile platform to be moved in a direction.

For example, the computer device controls, in response to the movement control operation on the mobile platform, the mobile platform to be moved in the virtual world, to change the terrain formed by the at least two terrain platforms.

Operation 360: Control, in response to a character control operation on a first virtual character, the first virtual character to interact with another virtual character in the at least two virtual characters on the terrain formed by the at least two terrain platforms.

The character control operation is a control operation on the first virtual character.

In an embodiment, the character control operation includes at least one of movement, skill casting, body posture adjustment, crawling, walking, running, cycling, jumping, driving, picking, shooting, attacking, throwing, and battling.

The another virtual character is a virtual character other than the first virtual character in the at least two virtual characters.

In an embodiment, the another virtual character includes at least one of a teammate virtual character, an opponent virtual character, and a non-player character. The interaction with the another virtual character in the at least two virtual characters includes at least one of shooting, attacking, throwing, dialoguing, and battling.

In conclusion, in the method provided in this embodiment of the present disclosure, a game instance play method is designed. At least one terrain platform in the virtual world is set as a mobile platform, so that a player can move the mobile platform by performing the movement control operation, and the player can autonomously change a position of the terrain platform in the virtual world, to change a terrain in the virtual world. Further, the player can autonomously change a terrain in a multiplayer battle scenario during a battle, and take full advantage of a terrain change achieved through movement of the mobile platform in the virtual world, to deal with a combat mechanism in the virtual world, and explore fun of an instance combat in space with a high degree of freedom. In this way, a game mechanism is enriched, complexity and playability of the game are enhanced, and the player is more interested in the game.

In some embodiments, the first virtual character is set to have the control permission for controlling the mobile platform by default. Therefore, operation 340 may be performed without performing operation 330.

In some embodiments, before operation 340, operation 330 is further included. Operation 330 is performed to obtain the control permission of the virtual character for the mobile platform, and operation 340 may be performed only after the virtual character obtains the control permission for the mobile platform.

Operation 330: Control, in response to a permission obtaining operation, the first virtual character to obtain the control permission for the mobile platform.

The permission obtaining operation is an operation of obtaining the control permission for the mobile platform. The control permission is a permission for controlling movement of the mobile platform, and may be specifically a permission for controlling the mobile platform to be moved in a direction.

For example, the computer device controls, in response to the permission obtaining operation, the first virtual character to obtain the control permission for the mobile platform.

In an embodiment, the computer device displays a permission obtaining button, and the permission obtaining operation includes a trigger operation on the permission obtaining button. The trigger operation includes at least one of a tap operation, a double-tap operation, a long press operation, and a touch operation. The computer device controls, in response to the trigger operation on the permission obtaining button, the first virtual character to obtain the control permission for the mobile platform.

In an embodiment, the virtual world includes a non-player character, where the non-player character is a game character that is not controlled by the player, and the non-player character is configured for indicating the control permission for the mobile platform. The permission obtaining operation includes an interaction operation between the first virtual character and the non-player character. The computer device controls, in response to the interaction operation between the first virtual character and the non-player character, the first virtual character to obtain the control permission for the mobile platform. The interaction operation includes at least one of dialoguing with a non-player character, exchanging a prop with the non-player character, or approaching the non-player character.

In an embodiment, it is preset that the virtual character can control a mobile platform on which the virtual character is currently located. The permission obtaining operation includes a displacement operation of displacing the first virtual character to the mobile platform. The computer device controls, in response to the displacement operation of displacing the first virtual character to the mobile platform, the first virtual character to obtain the control permission for the mobile platform.

In some embodiments, after controlling the first virtual character to obtain the control permission for the mobile platform, the computer device displays a quick time event (QTE) button in a skill area, for indicating the control permission obtained by the first virtual character.

In this embodiment, the permission obtaining operation is performed, and control of the mobile platform in the virtual world is transferred to the player, so that the player can move the mobile platform by performing the movement control operation, and the player can fully play an autonomous role. A plurality of players cooperate with each other, and a terrain change is achieved through movement of the mobile platform, to deal with a combat mechanism of an online game, and provide an implementation condition for the movement control operation by the player, so as to enhance complexity and playability of the game.

In some embodiments, the movement control operation is an operation of controlling the mobile platform to be moved by at least one grid in a first direction. In this case, the control permission obtained by the first virtual character is a first control permission, and the first control permission is a permission for controlling the mobile platform to be moved in the first direction.

For example, operation 330 is exemplarily implemented as follows: The computer device controls, in response to the first virtual character approaching a first non-player character, the first virtual character to obtain a first control permission indicated by the first non-player character, where the first control permission is a permission for controlling the mobile platform to be moved in the first direction.

In an embodiment, the first non-player character is one of at least two non-player characters located in the virtual world, and the at least two non-player characters are in one-to-one correspondence with at least two directions.

For example, the computer device displays the at least two non-player characters located in the virtual world. The first non-player character is one of the at least two non-player characters located in the virtual world, and the at least two non-player characters are in one-to-one correspondence with the at least two directions. The first non-player character may be selected by the player for approaching based on a movement direction that the player expects to select. The approaching means that a distance between the first virtual character and a non-player character is less than or equal to a distance threshold.

In this embodiment, a plurality of non-player characters are set in the virtual world, so that the player obtains a corresponding control permission after interacting with a non-player character. This can improve a sense of game participation of the player. In addition, a right of choice for the control permission can be transferred to the player, so that the player autonomously chooses to obtain a permission for controlling the mobile platform to be moved in a direction. This enhances playability, enriches a game mechanism, and improves game complexity.

### Movement control of the mobile platform

FIG. 4 is a flowchart of a virtual world-based interaction method according to an exemplary embodiment of the present disclosure. Operation 340 performed by the computer device is exemplarily implemented as operation 342.

Operation 342: Control, in response to the movement control operation of controlling the mobile platform to be moved in the first direction, the mobile platform to be moved in the first direction by at least one grid in the virtual world, where the grid is a step unit for movement of the mobile platform; and the first direction is one of at least two directions, and the at least two directions include at least two of east, west, south, north, up, and down.

In an embodiment, it is set that a movement direction of the mobile platform includes the at least two directions, where the at least two directions include at least two of east, west, south, north, up (also referred to as floating), and down (also referred to as sinking).

The first direction is one of the at least two directions.

In an embodiment, the first direction is indicated by the control permission obtained by the first virtual character. For example, the control permission is a permission for controlling the mobile platform to be moved westward, and in this case, the first direction is west.

The movement control operation is an operation of controlling the mobile platform to be moved by at least one grid in the first direction. For example, the movement control operation is to control the mobile platform to be moved by one grid in the first direction, or the movement control operation is to control the mobile platform to be moved by a plurality of grids in the first direction. In an embodiment, a quantity of grids moved by performing the movement control operation may be set by the player. For example, if the player sets that the quantity of grids moved by performing the movement control operation is 1, the movement control operation is to control the mobile platform to be moved by one grid in the first direction; or if the player sets that the quantity of grids moved by performing the movement control operation is 2, the movement control operation is to control the mobile platform to be moved by two grids in the first direction. In an embodiment, the quantity of grids moved by performing the movement control operation may be a default value preset by a technician. For example, if the default value is 1, the movement control operation is to control the mobile platform to be moved by one grid in the first direction.

In an embodiment, it is set in this embodiment that the mobile platform moves by at least one grid each time. The grid is a step unit for movement of the mobile platform. A size of the grid may be determined based on a volume of three-dimensional space in the virtual world. For example, referring to a top view (a) in FIG. 2, each square in the top view (a) represents one grid, and the mobile platform moves by one grid each time.

For example, the computer device controls, in response to the movement control operation of controlling the mobile platform to be moved in the first direction, the mobile platform to be moved in the first direction by at least one grid in the virtual world.

In this embodiment, the movement control operation is to move the mobile platform in the first direction. The computer device controls, in response to the movement control operation of controlling the mobile platform to be moved in the first direction, the mobile platform to be moved in the first direction by at least one grid in the virtual world. Such a movement control operation of moving at least one grid in a direction is performed, so that the player can implement movement control of the mobile platform, a terrain change in the virtual world is achieved, difficulty in movement control can be lowered, and a computing amount of the computer device can be reduced.

In some embodiments, there are at least two mobile platforms. Specifically, still referring to FIG. 4, operation 342 may be further implemented as operation 344.

Operation 344: Control, in response to the movement control operation of controlling the mobile platform to be moved in the first direction, a mobile platform that is in the at least two mobile platforms and that meets a movement condition to be moved in the first direction by at least one grid in the virtual world, where a mobile platform that is in the at least two mobile platforms and that does not meet the movement condition remains unchanged in the virtual world.

The movement condition is a condition that needs to be met by a mobile platform that can be successfully moved in the first direction this time.

In an embodiment, the movement condition is determined based on an expected movement position of the mobile platform. The expected movement position includes at least either of a movement end position and a movement intermediate position. The movement intermediate position is a position on a movement path during movement of the mobile platform. When the expected movement position is a movement end position, when the mobile platform is successfully moved to the expected movement position, the expected movement position may also be referred to as a position after movement.

For example, it is assumed that a mobile platform 1 is moved from a start position A to an end position B. In this case, the expected movement position includes the end position B. When the mobile platform 1 is successfully moved to the end position B, the end position B is also referred to as a position after movement, and the start position A is also referred to as a position before movement. It is assumed that a mobile platform 2 is moved from a start position A to an end position B, and positions on a movement path are sequentially: the start position A, an intermediate position D, an intermediate position E, and the end position B. In this case, the expected movement position includes the intermediate position D, the intermediate position E, and the end position B. The mobile platform 2 can be finally successfully moved to the end position B only after being successfully moved to the intermediate position D and the intermediate position E in sequence.

In some embodiments, the mobile platform that meets the movement condition includes at least one of the following:

at least one mobile platform whose expected movement position is not obstructed by a virtual obstacle;

at least one mobile platform whose expected movement position is not obstructed by another terrain platform;

at least one mobile platform whose expected movement position is not beyond a boundary line; and

at least one mobile platform that is not currently in a moving state.

In some embodiments, the virtual obstacle includes at least one of a fixed platform, a virtual building, and a virtual wall. For example, the virtual obstacle is a fixed platform. Because a position of the fixed platform in the virtual world remains unchanged, when the fixed platform is at an expected movement position, the mobile platform cannot be move to the expected movement position. For example, the computer device controls, in response to the movement control operation of controlling the mobile platform to be moved in the first direction, a mobile platform that is in the at least two mobile platforms and whose expected movement position is not obstructed by the virtual obstacle be to moved in the first direction by at least one grid in the virtual world, where a mobile platform whose expected movement position is obstructed by the virtual obstacle remains unchanged in the virtual world.

In some embodiments, the another terrain platform is a mobile platform that cannot continue to be moved during current movement, or a fixed platform that is immovable. For example, a west side of the mobile platform 1 is tangent to the boundary line, and an east side is adjacent to the mobile platform 2. When the current movement is moving westward by one grid, the mobile platform 1 cannot be moved westward. In this case, the mobile platform 1 has been located at an expected movement position of the mobile platform 2, and the mobile platform 2 cannot be moved westward due to obstruction of the mobile platform 1. For example, the computer device controls, in response to the movement control operation of controlling the mobile platform to be moved in the first direction, a mobile platform that is in the at least two mobile platforms and whose expected movement position is not obstructed by the another terrain platform to be moved in the first direction by at least one grid in the virtual world, where a mobile platform whose expected movement position is obstructed by the another terrain platform remains unchanged in the virtual world.

In some embodiments, the boundary line is a preset boundary. That is, the mobile platform can be moved only within a range of the boundary line and cannot be moved beyond the boundary line. When the expected movement position of the mobile platform is beyond the boundary line, the mobile platform cannot be moved to the expected movement position. For example, the computer device controls, in response to the movement control operation of controlling the mobile platform to be moved in the first direction, a mobile platform that is in the at least two mobile platforms and whose expected movement position is not beyond the boundary line to be moved in the first direction by at least one grid in the virtual world, where a mobile platform whose expected movement position is beyond the boundary line remains unchanged in the virtual world.

In some embodiments, it is set that when the mobile platform is in the moving state, the movement control operation cannot be performed on the mobile platform. For example, the computer device controls, in response to the movement control operation of controlling the mobile platform to be moved in the first direction, a mobile platform that is in the at least two mobile platforms and that is not in the moving state to be moved in the first direction by at least one grid in the virtual world, where a mobile platform that is in the moving state is always in the moving state in the virtual world.

In this embodiment, the computer device moves only a mobile platform that meets the movement condition, and a mobile platform that does not meet the movement condition remains unchanged, so that clipping can be effectively avoided, thereby improving accuracy of movement control of the mobile platform.

For ease of understanding, the foregoing embodiments are described below with reference to schematic diagrams.

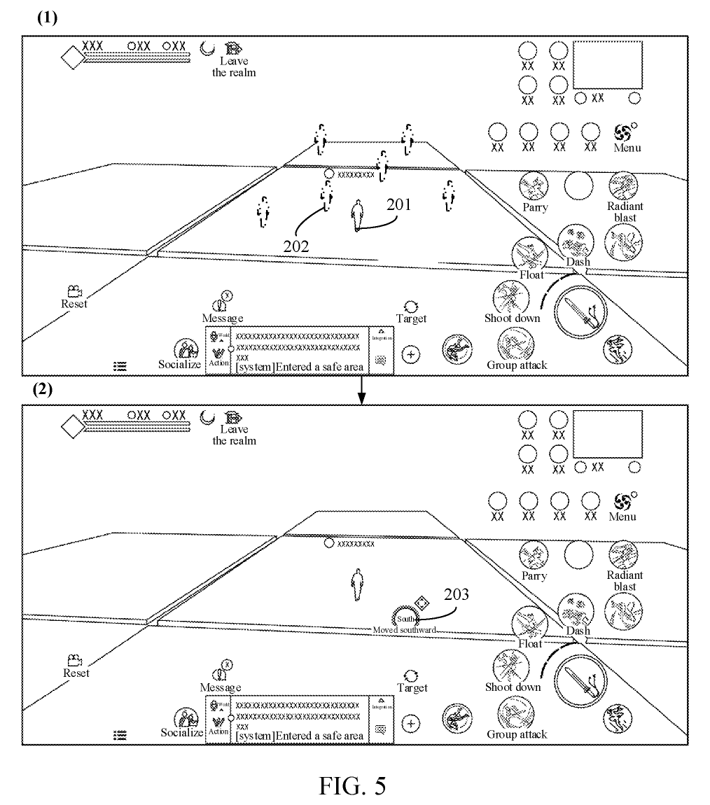

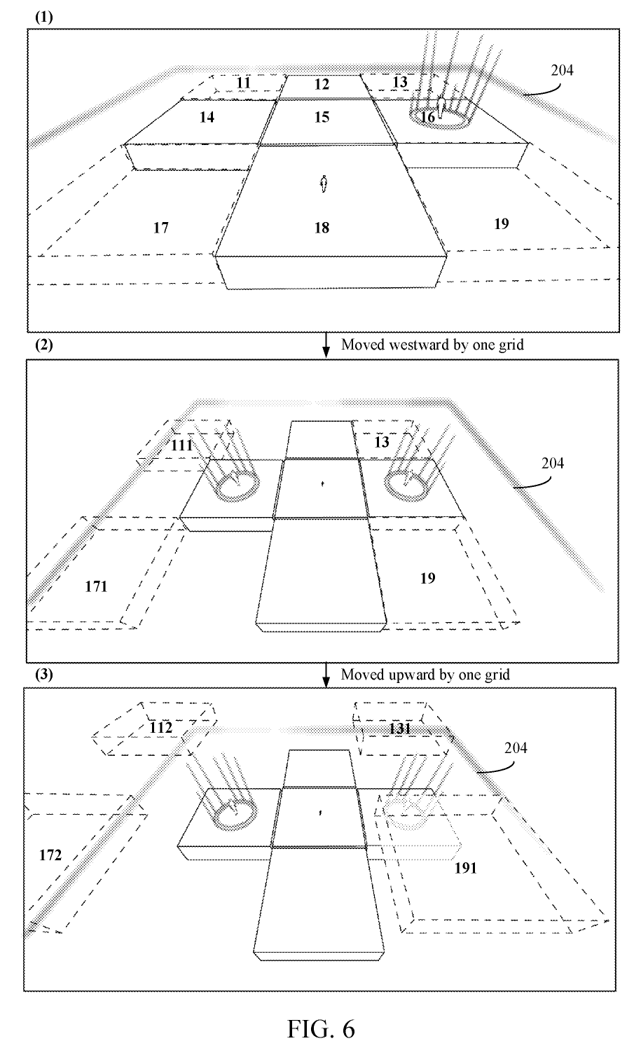

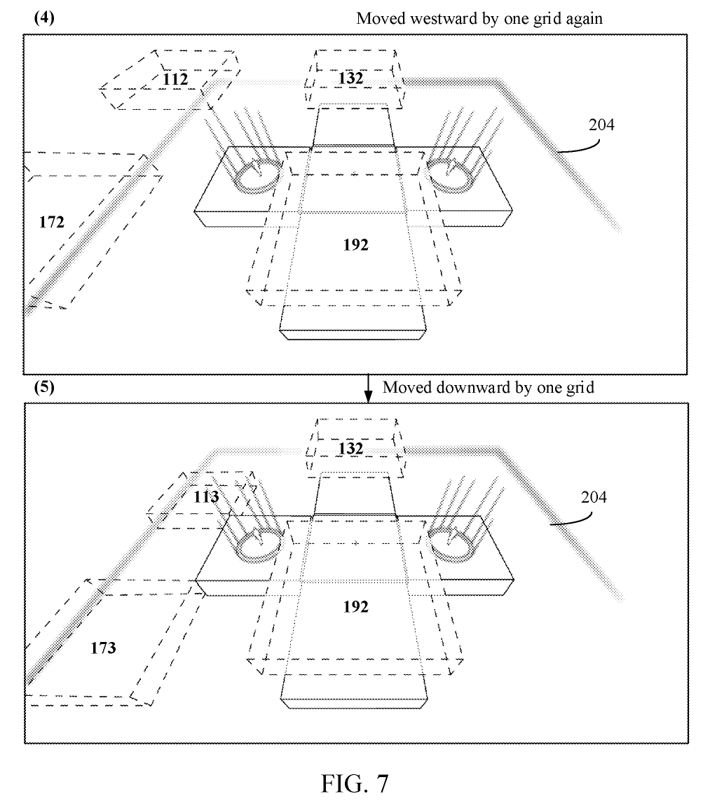

FIG. 5, FIG. 6, and FIG. 7 are schematic diagrams of a virtual world-based interaction method according to an exemplary embodiment of the present disclosure.

For example, the first virtual character approaches a non-player character to obtain the control permission for the mobile platform. As shown in a schematic diagram (1) in FIG. 5, the computer device displays a first virtual character 201 that is currently logged in to and a non-player character 202 that is located in the virtual world. The first virtual character 201 is displayed in a physical state, and the non-player character 202 is displayed in a ghosted state. Prompt information may be displayed above the non-player character 202, and the prompt information is configured for indicating the first virtual character 201 to interact with the non-player character 202 to obtain the control permission for the mobile platform. The computer device controls, in response to the first virtual character 201 approaching the non-player character 202, the first virtual character 201 to obtain the control permission for the mobile platform. As shown in a schematic diagram (2) in FIG. 5, the computer device further exemplarily prompts, in a form of a QTE button 203 in a player skill panel, the first virtual character 201 of the obtained control permission for the mobile platform.

As shown in a schematic diagram (1) in FIG. 6, the computer device displays at least two terrain platforms located in the virtual world, where the at least two terrain platforms include a fixed platform and a mobile platform. Fixed platforms are in a physical state, including: a terrain platform 12, a terrain platform 14, a terrain platform 15, a terrain platform 16, and a terrain platform 18. The fixed platforms are arranged in a cross shape for display. The fixed platform may be used as a main combat platform in a battle, and may be used as a virtual obstacle during movement of the mobile platform. Mobile platforms are displayed in a ghosted state, including: a terrain platform 11, a terrain platform 13, a terrain platform 17, and a terrain platform 19. The mobile platforms are distributed at four corners of the fixed platforms. In an embodiment, the computer device may first display at least two terrain platforms located in the virtual world, and then control the first virtual character 201 to obtain the control permission for the mobile platform. Alternatively, the computer device may first control the first virtual character 201 to obtain the control permission for the mobile platform, and then display at least two terrain platforms that slowly rise in the virtual world.

In some embodiments, the movement of the mobile platform follows: The movement control operation is to control the mobile platform to be moved by one grid in the first direction indicated by the movement control operation; the movement control operation is only to control movement of a mobile platform that meets the movement condition, where when the mobile platform is obstructed by the virtual obstacle or the another immovable terrain platform or reaches the boundary line, the movement condition is not met, and the mobile platform cannot be moved; and when a mobile platform is in the moving state, the movement condition is not met, and the movement control operation cannot be performed on the mobile platform.

A schematic diagram (1) in FIG. 6 shows initial positions of a fixed platform and a mobile platform that are located in the virtual world and that are displayed by the computer device. As shown in a schematic diagram (2) in FIG. 6, the computer device attempts to move all the mobile platforms westward by one grid in response to the movement control operation of moving a mobile platform westward. In this case, the mobile platform 11 is moved westward by one grid to become a mobile platform 111, and the mobile platform 17 is moved westward by one grid to become a mobile platform 171. Because the mobile platform 13 and the mobile platform 19 are obstructed by the fixed platforms, the mobile platform 13 and the mobile platform 19 are not moved this time, and positions remain unchanged. As shown in a schematic diagram (3) in FIG. 6, the computer device attempts to move all the mobile platforms upward by one grid in response to the movement control operation of moving a mobile platform upward. In this case, the mobile platform 111 is moved upward by one grid to become a mobile platform 112, the mobile platform 171 is moved upward by one grid to become a mobile platform 172, the mobile platform 13 is moved upward by one grid to become a mobile platform 131, and the mobile platform 19 is moved upward by one grid to become a mobile platform 191. As shown in a schematic diagram (4) in FIG. 7, the computer device attempts to move all the mobile platforms westward by one grid in response to the movement control operation of moving a mobile platform westward. In this case, the mobile platform 131 is moved westward by one grid to become a mobile platform 132, and the mobile platform 191 is moved westward by one grid to become a mobile platform 192. Because the mobile platform 112 and the mobile platform 172 have reached a boundary line 204, the mobile platform 112 and the mobile platform 172 are not moved this time, and positions remain unchanged. As shown in a schematic diagram (5) in FIG. 7, the computer device attempts to move all the mobile platforms downward by one grid in response to the movement control operation of moving a mobile platform downward. In this case, the mobile platform 112 is moved downward by one grid to become a mobile platform 113, and the mobile platform 172 is moved downward by one grid to become a mobile platform 173. Because the mobile platform 132 and the mobile platform 192 are obstructed by the fixed platforms, the mobile platform 132 and the mobile platform 192 are not moved this time, and positions remain unchanged. In this way, movement of the mobile platform ends. In an embodiment, the computer device controls, in response to a character control operation on the first virtual character 201, the first virtual character 201 to interact with another virtual character on the terrain formed by the at least two terrain platforms.

### Mobile settings of the mobile platform

In some embodiments, when the mobile platform is set to be moved, all virtual characters, non-player characters, and virtual objects located on the mobile platform may be moved together.

For example, the computer device displays, in response to the first virtual character being located on the mobile platform, the first virtual character moved with the mobile platform.

In this embodiment, when the first virtual character is located on the mobile platform, the first virtual character may be moved with the mobile platform. This enriches movement mechanics of the player, and enhances entertainment value and playability of the game.

In some embodiments, when a virtual character is located on the mobile platform, movement of the virtual character is considered as being moved with the mobile platform rather than autonomous movement of the virtual character. For example, a virtual character is in an immobilized state, that is, the virtual character cannot use any movement skills, but the virtual character can still be moved with the mobile platform.

For example, the first virtual character is in the immobilized state, and the immobilized state is a state in which any skill is not allowed for use. The computer device displays, in response to the first virtual character being located on the mobile platform, the first virtual character that is in the immobilized state and moved with the mobile platform.

In this embodiment, when the first virtual character is located on the mobile platform, the first virtual character may also be move with the mobile platform even if in the immobilized state. This enriches movement mechanics of the player, and enhances entertainment value and playability of the game.

In some embodiments, the first virtual character has a buff skill, and the buff skill is a skill having a buff effect on skill casting of the first virtual character. The buff skill includes at least one of a charging skill, a health point boost skill, and purchasing a virtual prop. When the virtual character is not located on the mobile platform and casts the buff skill, if the virtual character is moved, skill casting is interrupted. However, when the virtual character is located on the mobile platform and casts the buff skill on the mobile platform, the virtual character may be moved with the mobile platform, and skill casting is not interrupted. The foregoing buff skill may be exemplarily replaced with at least one of an attack skill, a shooting skill, and a combat skill that attack an opponent virtual character.

For example, the computer device displays, in response to the first virtual character being located on the mobile platform and the first virtual character casting the buff skill, a casting animation of the buff skill moved with the mobile platform. If the casting animation does not stop, it indicates that skill casting is not interrupted.

In this embodiment, when the first virtual character is located on the mobile platform and casts a skill, the first virtual character may be moved with the mobile platform, and skill casting is not interrupted. This enriches movement and skill casting mechanics of the player, and enhances entertainment value and playability of the game.

In some embodiments, it is set that when the virtual character casts a skill on the mobile platform, a skill action range corresponding to the skill is also moved with the mobile platform, and skill casting is not interrupted. This embodiment is further applicable to a case that the opponent virtual character casts an opponent skill on the mobile platform to attack the virtual character, the virtual character may control a position of the mobile platform by performing the movement control operation, so that the virtual character is located beyond an attack range of the opponent skill cast by the opponent virtual character.

For example, the another virtual character may include an opponent virtual character, the opponent virtual character has an opponent skill, and the opponent virtual character is located on the mobile platform. The computer device displays, in response to the opponent virtual character being located on the mobile platform and the opponent virtual character casting the opponent skill, a casting animation and an attack range of the opponent skill moved with the mobile platform.

In this embodiment, when the opponent virtual character is located on the mobile platform and casts the opponent skill, the opponent virtual character may also be moved with the mobile platform and the skill is not interrupted. This is beneficial to the player to win the opponent virtual character in this manner when fighting against the opponent virtual character, to enrich game mechanisms and enhance complexity and playability of the game.

In some embodiments, the virtual character may be displaced (moved) by performing a short-distance instantaneous displacement operation (or a long-distance instantaneous transportation operation), and the virtual character may be further moved with the mobile platform. Therefore, to reduce a possibility of a position error caused by the computer device, when the virtual character is located on the mobile platform, it may be further set that the short-distance instantaneous displacement operation (or the long-distance instantaneous transportation operation) of the virtual character is prohibited on the mobile platform, while operations such as crawling, walking, running, cycling, and jumping are not affected. According to the foregoing embodiments, the position error caused by the computer device is less prone to occur.

In some embodiments, the mobile platform may alternatively autonomously move based on a designated path. For example, a combat scenario of the first virtual character is in movement. Alternatively, the mobile platform may move according to a rule, rather than being controlled by the first virtual character. For example, the first virtual character collapses the mobile platform by breaking the ground, causing a terrain change to confront a combat mechanism.

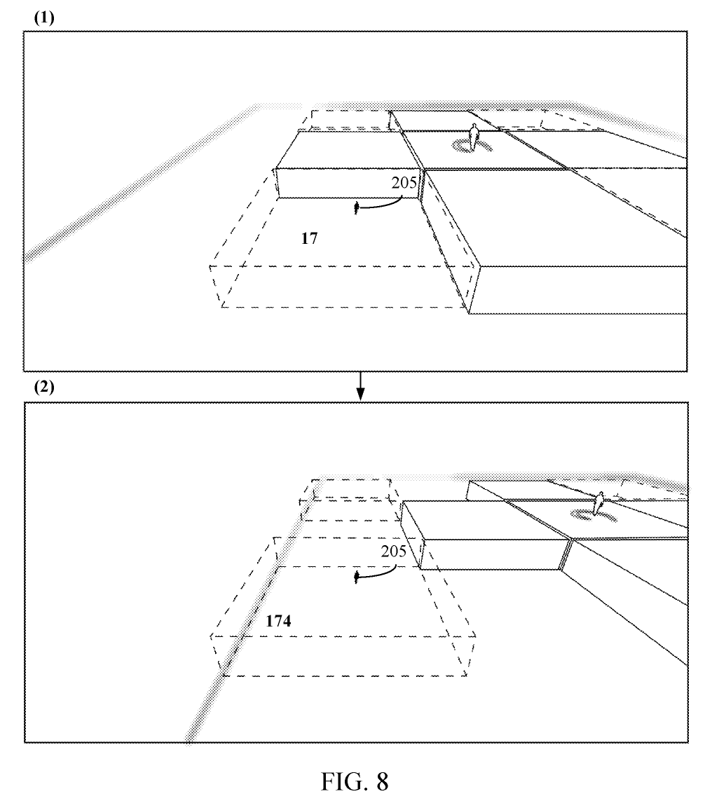

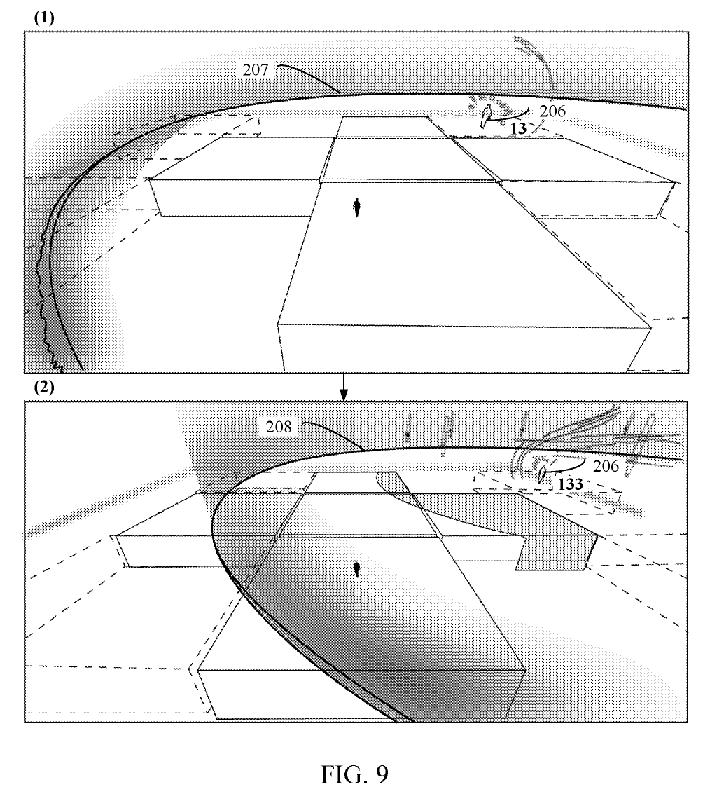

For example, FIG. 8 and FIG. 9 are schematic diagrams of a virtual world-based interaction method according to an exemplary embodiment of the present disclosure.

As shown in a schematic diagram (1) in FIG. 8, a first virtual character 205 is located on the mobile platform 17, and the first virtual character 205 may be moved together when the mobile platform 17 is moved. As shown in a schematic diagram (2) of FIG. 8, the mobile platform 17 moves westward by one grid to become a mobile platform 174, and the computer device displays, in response to the first virtual character 205 being located on the mobile platform 17, the first virtual character 205 moved with the mobile platform 17.

As shown in a schematic diagram (1) in FIG. 9, an opponent virtual character 206 is located on the mobile platform 13, and the opponent virtual character 206 casts an opponent skill. In this case, an attack range of the opponent skill is a range 207. Therefore, when the mobile platform 13 is moved, the opponent virtual character 206 may be moved together, the attack range is also moved with the mobile platform, and skill casting is not interrupted. As shown in a schematic diagram (2) in FIG. 9, the mobile platform 13 is moved eastward by one grid to become a mobile platform 133, and the computer device displays, in response to the opponent virtual character 206 being located on the mobile platform 13 and the opponent virtual character 206 casting an opponent skill, a casting animation and an attack range of the opponent skill moved with the mobile platform 13. When the mobile platform 13 is moved eastward by one grid to become the mobile platform 133, an attack range of the opponent skill is a range 208.

### Combat mechanism based on the mobile settings of the mobile platform

In some embodiments, the another virtual character includes an opponent virtual character, the opponent virtual character has an opponent skill, and the opponent virtual character is located on the mobile platform. Because the mobile platform has a movement direction, the player may control the virtual character to be moved in an opposite direction of the movement direction, to avoid attack from the opponent virtual character. Operation 360 may be exemplarily replaced with operation 361.

Operation 361: Control, in response to the character control operation on the first virtual character, the first virtual character to be moved in the opposite direction of the movement direction corresponding to the mobile platform, so that the first virtual character is moved away from the attack range of the opponent skill.

For example, the computer device controls, in response to the character control operation on the first virtual character, the first virtual character to be moved in the opposite direction of the movement direction corresponding to the mobile platform, so that the first virtual character is moved away from the attack range of the opponent skill.

FIG. 10 is a schematic diagram of a virtual world-based interaction method according to an exemplary embodiment of the present disclosure. As shown in a schematic diagram (a) in FIG. 10, fixed platforms include the terrain platform 12, the terrain platform 14, the terrain platform 15, the terrain platform 16, and the terrain platform 18, and mobile platforms include the terrain platform 11, the terrain platform 13, the terrain platform 17, and the terrain platform 19. An opponent virtual character 50 is located on the mobile platform 13, and in this case, an attack range of an opponent skill cast by the opponent virtual character 50 is a range 51. As shown in a schematic diagram (b) in FIG. 10, after the mobile platform 13 is moved, the mobile platform 13 becomes a mobile platform 13A, and the opponent virtual character 50 and the attack range of the opponent skill cast by the opponent virtual character 50 are moved with the mobile platform 13. In this case, the attack range of the opponent skill cast by the opponent virtual character 50 is a range 52.

In this case, a combat mechanism is that all virtual characters are moved in the opposite direction of the movement direction of the mobile platform, to leave attack ranges. The computer device controls, in response to the character control operation on the first virtual character, the first virtual character to be moved in the opposite direction of the movement direction corresponding to the mobile platform, so that the first virtual character is moved away from the attack range of the opponent skill.

In some embodiments, it is assumed that the first virtual character is currently located on a fixed platform. The another virtual character includes a teammate virtual character, the first virtual character is hit by the opponent skill, the opponent skill is configured for causing a fixed platform on which the first virtual character is currently located to be in a debuff skill state, and the debuff skill state spreads to an adjacent terrain platform. In this case, when the debuff skill state does not completely spread to an adjacent terrain platform, the player may control the first virtual character to be moved away from a combat area in which the teammate virtual character is located, to prevent the teammate virtual character from being affected by the debuff skill state. The debuff skill state is a platform state in which skill casting of the first virtual character located on the fixed platform is debuffed. Operation 360 may be exemplarily replaced with operation 362.

Operation 362: Control, in response to the character control operation on the first virtual character, the first virtual character to be moved to the mobile platform, so that the first virtual character is moved with the mobile platform to be away from the combat area in which the teammate virtual character is located.

For example, the computer device controls, in response to the character control operation on the first virtual character, the first virtual character to be moved to the mobile platform, so that the first virtual character is moved with the mobile platform to be away from the combat area in which the teammate virtual character is located.

In some embodiments, it is assumed that the first virtual character is currently located on a mobile platform. The another virtual character includes a teammate virtual character, the first virtual character is hit by the opponent skill, the opponent skill is configured for causing a mobile platform on which the first virtual character is currently located to be in a debuff skill state, and the debuff skill state spreads to an adjacent terrain platform. In this case, when the debuff skill state does not completely spread to an adjacent terrain platform, the player may perform the movement control operation to control the mobile platform to be moved away from the combat area in which the teammate virtual character is located, to prevent the teammate virtual character from being affected by the debuff skill state.

For example, the computer device displays, in response to the first virtual character being located on the mobile platform and the first virtual character being hit by the opponent skill, the first virtual character moved with the mobile platform, so that the first virtual character is moved away from the combat area in which the teammate virtual character is located.

FIG. 11 is a schematic diagram of a virtual world-based interaction method according to an exemplary embodiment of the present disclosure. As shown in a schematic diagram (a) in FIG. 11, the opponent virtual character designates a virtual character 61 and a virtual character 62 to put down ice swords, the ice swords change the mobile platform 17 on which the virtual character 61 is located and the mobile platform 19 on which the virtual character 62 is located to be in a freezing state, and the freezing state spreads to an adjacent terrain platform.

In this case, a combat mechanism is that a mobile platform on which a virtual character hit by the opponent skill is located is moved away from the combat area in which the teammate virtual character is located. As shown in a schematic diagram (b) in FIG. 11, the computer device controls, in response to the movement control operation, the mobile platform 17 to be moved to become a mobile platform 17D, and the mobile platform 19 to be moved to become a mobile platform 19A, so that the mobile platform 17 and the mobile platform 19 are moved away from a main battlefield.

In some embodiments, the another virtual character includes an opponent virtual character, the opponent virtual character has an opponent skill, and the opponent skill has a skill cracking position. The skill cracking position is a position at which the opponent skill cannot be cast. In an embodiment, the skill cracking position is also referred to as a safe position. The skill cracking position may be determined by the player, or the computer device may display prompt information for the skill cracking position. The player may control the first virtual character to be moved to the skill cracking position, to avoid attack. Operation 360 may be exemplarily replaced with operation 363.

Operation 363: Control, in response to the character control operation on the first virtual character, the first virtual character to be moved to the mobile platform, so that the first virtual character is moved with the mobile platform to the skill cracking position.

For example, the computer device controls, in response to the character control operation on the first virtual character, the first virtual character to be moved to the mobile platform, so that the first virtual character is moved with the mobile platform to the skill cracking position.

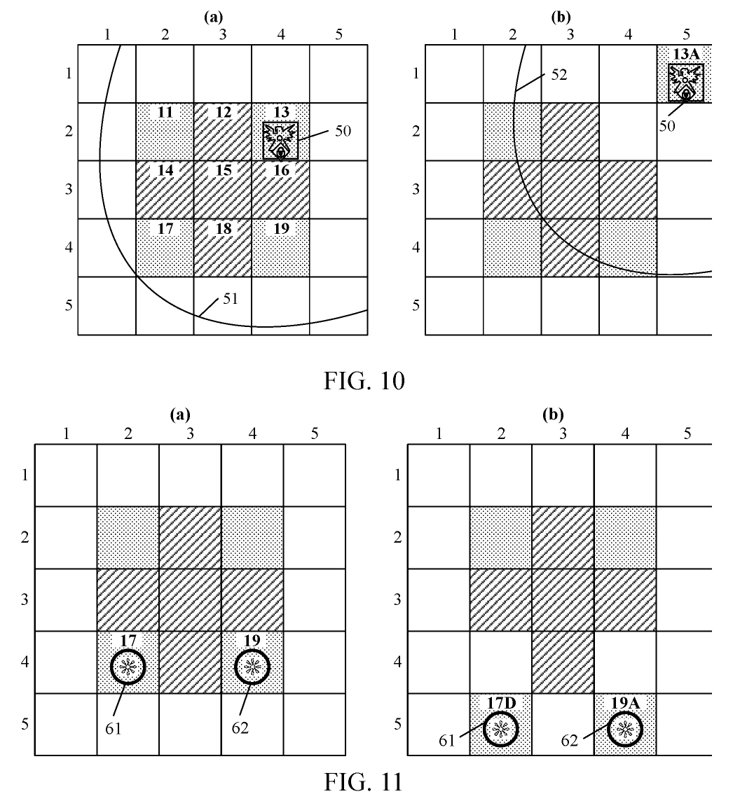

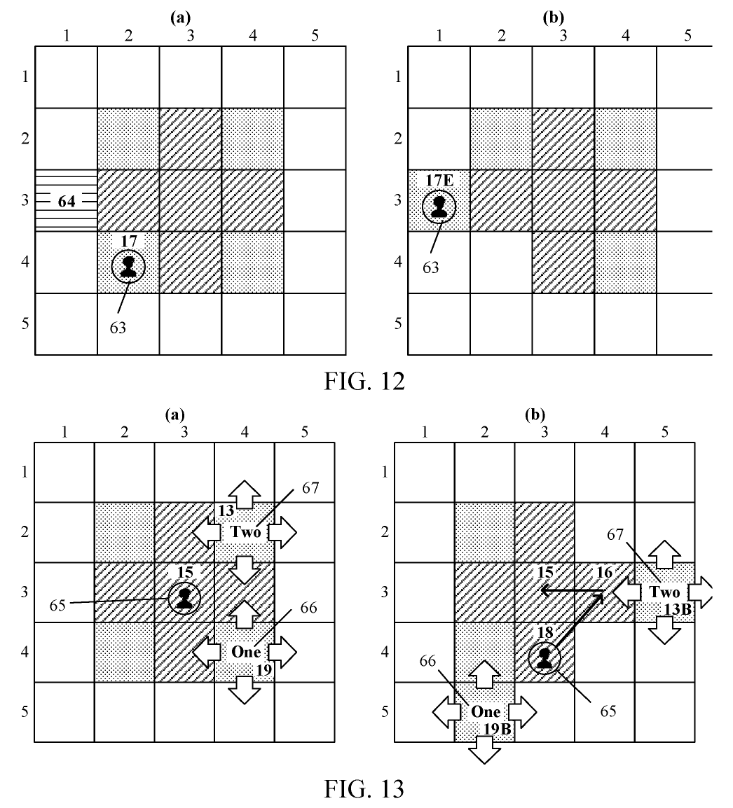

FIG. 12 is a schematic diagram of a virtual world-based interaction method according to an exemplary embodiment of the present disclosure. The opponent virtual character gradually decelerates all the virtual characters to be in the immobilized state. In this case, the skill cracking position (a safe area position) appears. After a period of time, the opponent virtual character releases an opponent skill, and a player who is not at the skill cracking position may be severely injured. In this case, a combat mechanism is that before the virtual character is completely immobilized, the virtual character is displaced to a mobile platform, and the mobile platform is used to transfer the virtual character to the skill cracking position, to prevent the virtual character from being attacked by the opponent virtual character.

As shown in a schematic diagram (a) in FIG. 12, a position 64 is the skill cracking position of the opponent skill of the opponent virtual character. In this case, the computer device controls, in response to the character control operation on a first virtual character 63, the first virtual character 63 to be moved to the mobile platform 17. As shown in a schematic diagram (b) in FIG. 12, the first virtual character 63 is moved to the skill cracking position 64 with the mobile platform 17, that is, after the mobile platform 17 is moved, the mobile platform 17 becomes a mobile platform 17E.

In some embodiments, the another virtual character includes at least two split characters corresponding to the opponent virtual character, and the at least two split characters each have a repelling skill. The repelling skill is a skill of moving the virtual character backward by at least one grid in a casting direction of the repelling skill. Therefore, when the repelling skill is cast, the first virtual character is backward by at least one grid when being hit. In this embodiment, it is set that the first virtual character is located right in a center of a combat area after being repelled. Therefore, the first virtual character may be moved to an appropriate position based on positions of the split characters, so that the first virtual character is located right at the center of the combat area after being repelled. Operation 360 may be exemplarily replaced with operation 364.

Operation 364: Control, in response to the character control operation on the first virtual character, the first virtual character to move to a first position, where the first position is a position at which the first virtual character is repelled from the first position to the center of the combat area after the at least two split characters separately cast the repelling skill.

For example, the computer device controls, in response to the character control operation on the first virtual character, the first virtual character to move to a first position, where the first position is a position at which the first virtual character is repelled from the first position to the center of the combat area after the at least two split characters separately cast the repelling skill.

In an embodiment, when the at least two split characters are located on at least two mobile platforms, the computer device further displays, in response to the at least two split characters being located on the at least two mobile platforms, the at least two split characters moved with the at least two mobile platforms, so that the at least two split characters repel the first virtual character from a current position to the center of the combat area after separately casting the repelling skill at a position after movement.

FIG. 13 is a schematic diagram of a virtual world-based interaction method according to an exemplary embodiment of the present disclosure. As shown in a schematic diagram (a) in FIG. 13, the opponent virtual character includes two split characters, namely, a first split character 66 and a second split character 67. The first split character 66 and the second split character 67 each may cast a repelling skill. In this embodiment, it is set that the first virtual character 65 is exactly located at a center 15 of the combat area after being sequentially repelled by the first split character 66 and the second split character 67. As shown in a schematic diagram (b) in FIG. 13, the computer device displays, in response to the first split character 66 being located on the mobile platform 19 and the second split character 67 being located on the mobile platform 13, the first split character 66 moved with the mobile platform 19 and the second split character 67 moved with the mobile platform 13, so that the first split character 66 is moved to a mobile platform 19B, and the second split character 67 is moved to a mobile platform 13B. The computer device further controls, in response to the character control operation on the first virtual character 65, the first virtual character 65 to be moved to a fixed platform 18, the first virtual character 65 is repelled from the fixed platform 18 to a fixed platform 16 after the first split character 66 casts the repelling skill, and the first virtual character 65 is repelled from the fixed platform 16 to a fixed platform 15, namely, a center of the combat area, after the second split character 67 casts the repelling skill.

In some embodiments, the another virtual character includes an opponent virtual character; and there may be a plurality of opponent virtual characters, or one opponent virtual character may include a plurality of split characters. In this case, the player may control each virtual character to be moved a position of one opponent virtual character or split character, to attack the opponent virtual character. Operation 360 may be exemplarily replaced with operation 365.

Operation 365: Control, in response to the character control operation on the first virtual character, the first virtual character to be moved to the mobile platform, so that the first virtual character is moved with the mobile platform to a position at which the opponent virtual character is located, to interact with the opponent virtual character.

For example, the computer device controls, in response to the character control operation on the first virtual character, the first virtual character to be moved to the mobile platform, so that the first virtual character is moved with the mobile platform to the position at which the opponent virtual character is located, to interact with the opponent virtual character.

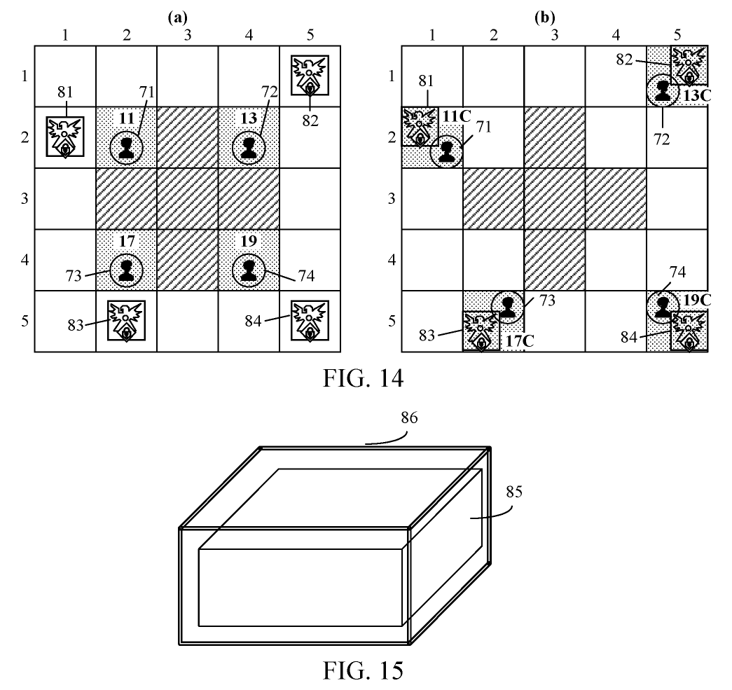

FIG. 14 is a schematic diagram of a virtual world-based interaction method according to an exemplary embodiment of the present disclosure. An opponent virtual character calls a split character in the entire combat space and charges. After a period of time, if there is a split character remaining, all virtual characters are directly killed. In this case, a combat mechanism is that virtual characters are dispersed on various mobile platforms, moved to positions of split characters, and killed. To ensure slaying efficiency, it is necessary to keep a plurality of mobile platforms as much as possible as can arrive at a position of a split character at the same time.

As shown in a schematic diagram (a) in FIG. 14, an opponent virtual characters include a split character 81, a split character 82, a split character 83, and a split character 84. A virtual character in our camp include a virtual character 71, a virtual character 72, a virtual character 73, and a virtual character 74. As shown in a schematic diagram (b) in FIG. 14, in response to a character control operation, the computer device causes the virtual character 71 to be moved to a mobile platform 11, the virtual character 72 to be moved to a mobile platform 13, the virtual character 73 to be moved to a mobile platform 17, and the virtual character 74 to be moved to a mobile platform 19. The virtual character 71 is moved to a position (a mobile platform 11C) of the split character 81 with the mobile platform 11 and kills the split character 81; the virtual character 72 is moved to a position (a mobile platform 13C) of the split character 82 with the mobile platform 13 and kills the split character 82; the virtual character 73 is moved to a position (a mobile platform 17C) of the split character 83 with the mobile platform 17 and kills the split character 83; and the virtual character 74 is moved to a position (a mobile platform 19C) of the split character 84 the mobile platform 19 and kills the split character 84.

In some embodiments, the foregoing opponent virtual character may be specifically a "BOSS" role in a virtual world, or may be an opponent virtual character that is in different fighting teams with the first virtual character. When a plurality of virtual characters fight by driving a virtual article having a moving function, the virtual article having a moving function may also be considered as a mobile platform. For example, a player performs an air battle by driving a virtual airship, or moves to an expected arrival position through a hot balloon, a pumice, or the like.

In the foregoing embodiment, a plurality of combat mechanisms set based on movement of a mobile platform are provided, so that the player can fully play an autonomous role. A plurality of players cooperate with each other, and a terrain change is achieved through movement of the mobile platform in the virtual world, to deal with a combat mechanism of an online game. This enriches game mechanisms and enhances complexity and playability of the game.

### Basic expression of the mobile platform

### 1. Collision expression of the mobile platform

In some embodiments, a collision point of the mobile platform is set as a platform center of the mobile platform. If a virtual character is not on a mobile platform, the computer device moves the virtual character and the mobile platform by using world coordinates. When a virtual character is located on a mobile platform, the computer device performs movement on the corresponding mobile platform by using relative coordinates.

In an embodiment, the computer device controls, in response to the first virtual character being not located on the mobile platform, the first virtual character to be moved in the virtual world based on world coordinates of the first virtual character in a world coordinate system, where the world coordinate system is a coordinate system created based on the virtual world.

In an embodiment, the computer device controls, in response to the first virtual character being located on the mobile platform, the first virtual character to be moved in the virtual world based on relative coordinates of the first virtual character in a relative coordinate system, where the relative coordinate system is a coordinate system created based on the mobile platform on which the first virtual character is currently located.

### 2. Determining of whether the virtual character enters and exits the mobile platform

In some embodiments, to dynamically determine whether the virtual character enters the mobile platform (is located on the mobile platform), a geometric body wrapping the mobile platform is used as a determining area. FIG. 15 is a schematic diagram of a mobile platform according to an exemplary embodiment of the present disclosure. The geometric body 85 represents a mobile platform, and a geometric body 86 is a three-dimensional area corresponding to the mobile platform, that is, a determining area.

In some embodiments, a terminal determines in each frame, whether the virtual character enters the three-dimensional area corresponding to the mobile platform, and if the virtual character is not located on the mobile platform, the terminal separately controls the mobile platform and the virtual character to be moved in the virtual world based on the world coordinates, without needing to be checked by a server, and movement determining of the virtual character and movement of the mobile platform subject to the terminal. When the virtual character is located on the mobile platform, the terminal sends a check request to the server, and the server checks a position of the virtual character based on the check request. In this way, computational complexity of both the terminal and the server can be effectively controlled, thereby saving computing resources.

For example, the computer device obtains the relative coordinates of the first virtual character in the relative coordinate system in response to the first virtual character entering a three-dimensional area corresponding to the mobile platform; sends a check request to a server, where the check request carries the relative coordinates, and the server is configured to check a position of the first virtual character based on the relative coordinates; and controls the first virtual character to be moved in the virtual world based on a check result returned by the server.

### 3. Movement of relative coordinates

In some embodiments, an interval at which the server updates collision of the mobile platform is 500 ms, that is, update twice in 1 second. The terminal needs to update positions of the mobile platform and the virtual character in each frame to accurately determine the positions of the mobile platform and the virtual character. Generally, 1 second may include 24 frames. When the virtual character is located on the mobile platform, because the server updates the position of the virtual character slowly and the terminal updates the position of the virtual character quickly, and the virtual character is further moved with the mobile platform, and runs, jumps, and the like on the mobile platform, when the server updates data, if the terminal notifies the server of the position of the virtual character by using the world coordinates, the position of the virtual character may have a large error, and position dragging may be frequently triggered. When the terminal notifies the server of the position of the virtual character by using the relative coordinates of the mobile platform, the error of the position of the virtual character may become very small. In this embodiment, the mobile platform-based combat mechanism also supports the terminal in determining the position of the virtual character by using the relative coordinates.

### Logic of implementing movement of the mobile platform

In some embodiments, the computer device may generate marked points of all movable positions corresponding to the mobile platform in the virtual world. Whether the mobile platform can be moved to the movable position can be determined by marking the marked point to be in an occupied state or in a non-occupied state.

For example, the computer device controls, in response to a marked point corresponding to an expected movement position of the mobile platform being not in an occupied state, the mobile platform to move to the expected movement position; and unmarks a marked point corresponding to a position of the mobile platform before movement as being in the occupied state, and marking the marked point corresponding to the expected movement position of the mobile platform as being in the occupied state.

In some embodiments, logic of implementing movement of the mobile platform mainly includes the following:

1. A player team enters an instance scenario, and after control permissions for moving the mobile platform in various directions are all acquired, the mobile platform is displayed in the instance scenario.

2. Generate marked points for movable positions corresponding to all mobile platforms in the instance scenario.

3. Mark a marked point at which an initial position of the mobile platform is located as being in an occupied state.

4. When the player releases a movement control operation, all the mobile platforms perform detection at an expected movement position in an expected movement direction, delete the occupied state of a marked point corresponding to a current position if the marked point corresponding to the expected movement position is not in the occupied state, and are moved in the expected movement direction by one grid to the expected movement position.

5. After the movement of the mobile platform ends, a marked point corresponding to the current position of the mobile platform is marked as being in the occupied state.

Operations 1, 2, and 3 are initialized operations, and are performed only once after an instance scenario is generated. Operations 4 and 5 are performed once each time when the movement control operation is released. When a movable position corresponding to the mobile platform needs to be added, a marked point corresponding to the movable position is added and marked, which has high expansibility.

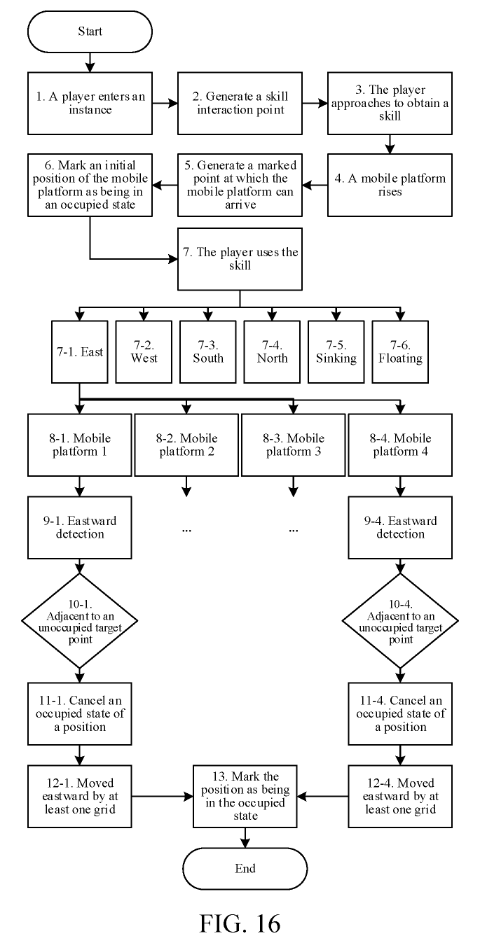

FIG. 16 is a flowchart of a virtual world-based interaction method according to an exemplary embodiment of the present disclosure. For example, there are four mobile platforms, namely, a mobile platform 1, a mobile platform 2, a mobile platform 3, and a mobile platform 4. Logic of implementing movement of the mobile platform is briefly described as follows:

1. A player enters the instance scenario.

2. Generate a skill interaction point based on a position at which a non-player character located in the instance scenario is located.

3. The player approaches a first non-player character to obtain control permission that is indicated by the first non-player character and that is configured for moving the mobile platform in a first direction by at least one grid. In this embodiment, the first direction is set to east.

4. The mobile platform that slowly rises is displayed in the instance scenario after control permissions for moving the mobile platform eastward, westward, southward, northward, upward, and downward are all obtained.

5. Generate marked points based on movable positions corresponding to all mobile platforms.

6. Mark a marked point at which an initial position of the mobile platform is located as being in an occupied state.

7. In response to a movement control operation released by the player, the movement control operation is configured for moving the mobile platform eastward by at least one grid. For a mobile platform 1, operations 8-1, 9-1, 10-1, 11-1, and 12-1 are sequentially performed, and for a mobile platform 4, operations 8-4, 9-4, 10-4, 11-4, and 12-4 are sequentially performed, where operations performed for each mobile platform are numbered differently only.

The mobile platform 1 is used as an example. 8-1: Determine that a mobile platform 1 is currently moved.

9-1. Perform detection eastward.

10-1: Detect that a marked point corresponding to an expected movement position (if movement is performed by one grid each time, the expected movement position is an adjacent position of the current position) is not in an occupied state.

11-1: Delete the occupied state of the marked point corresponding to the current position if the marked point corresponding to the expected movement position is not in the occupied state.

12-1: Moved eastward by at least one cell.

13: Mark a marked point corresponding to the current position of the mobile platform as being in the occupied state.

So far, movement ends.

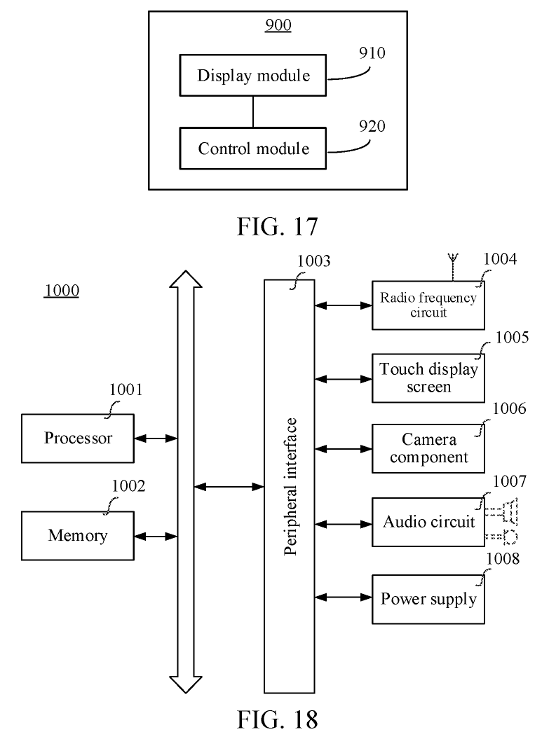

FIG. 17 is a block diagram of a virtual world-based interaction apparatus 900 according to an exemplary embodiment of the present disclosure. The virtual world-based interaction apparatus 900 includes:

a display module 910, configured to display at least two terrain platforms located in a virtual world, the at least two terrain platforms being platforms for supporting at least two virtual characters, and at least one of the at least two terrain platforms being a mobile platform; and

a control module 920, configured to control, in response to a movement control operation on the mobile platform, the mobile platform to be moved in the virtual world, to change a terrain formed by the at least two terrain platforms,

the control module 920 being configured to control, in response to a character control operation on a first virtual character, the first virtual character to interact with another virtual character in the at least two virtual characters on the terrain formed by the at least two terrain platforms.

In some embodiments, the control module 920 is configured to control, in response to the movement control operation of controlling the mobile platform to be moved in a first direction, the mobile platform to be moved in the first direction by at least one grid in the virtual world, where the grid is a step unit for movement of the mobile platform; and

the first direction is one of at least two directions, and the at least two directions include at least two of east, west, south, north, up, and down.

In some embodiments, there are at least two mobile platforms; and

the control module 920 is configured to control, in response to the movement control operation of controlling the mobile platform to be moved in the first direction, a mobile platform that is in the at least two mobile platforms and that meets a movement condition to be moved in the first direction by at least one grid in the virtual world, where

a mobile platform that is in the at least two mobile platforms and that does not meet the movement condition remains unchanged in the virtual world.

In some embodiments, the mobile platform that meets the movement condition includes at least one of the following:

at least one mobile platform whose expected movement position is not obstructed by a virtual obstacle;

at least one mobile platform whose expected movement position is not obstructed by another terrain platform;

at least one mobile platform whose expected movement position is not beyond a boundary line; and

at least one mobile platform that is not currently in a moving state.

In some embodiments, the display module 910 is configured to display, in response to the first virtual character being located on the mobile platform, the first virtual character moved with the mobile platform.

In some embodiments, the first virtual character is in an immobilized state, and the immobilized state is a state in which any skill is not allowed for use; and

the display module 910 is configured to display, in response to the first virtual character being located on the mobile platform, the first virtual character that is in the immobilized state and moved with the mobile platform.

In some embodiments, the first virtual character has a buff skill; and

the display module 910 is configured to display, in response to the first virtual character being located on the mobile platform and the first virtual character casting the buff skill, a casting animation of the buff skill moved with the mobile platform.

In some embodiments, the another virtual character includes an opponent virtual character, the opponent virtual character has an opponent skill, and the opponent virtual character is located on the mobile platform; and

the display module 910 is configured to display, in response to the opponent virtual character being located on the mobile platform and the opponent virtual character casting the opponent skill, a casting animation and an attack range of the opponent skill moved with the mobile platform.

In some embodiments, the another virtual character includes an opponent virtual character, the opponent virtual character has an opponent skill, and the opponent virtual character is located on the mobile platform; and

the control module 920 is configured to control, in response to the character control operation on the first virtual character, the first virtual character to be moved in an opposite direction of a movement direction corresponding to the mobile platform, so that the first virtual character is moved away from the attack range of the opponent skill.

In some embodiments, the another virtual character includes a teammate virtual character, the first virtual character is hit by the opponent skill, the opponent skill is configured for causing a fixed platform on which the first virtual character is currently located to be in a debuff skill state, and the debuff skill state spreads to an adjacent terrain platform; and

the control module 920 is configured to control, in response to the character control operation on the first virtual character, the first virtual character to be moved to the mobile platform, so that the first virtual character is moved with the mobile platform to be away from a combat area in which the teammate virtual character is located.

In some embodiments, the another virtual character includes an opponent virtual character, the opponent virtual character has an opponent skill, and the opponent skill has a skill cracking position; and

the control module 920 is configured to control, in response to the character control operation on the first virtual character, the first virtual character to be moved to the mobile platform, so that the first virtual character is moved with the mobile platform to the skill cracking position.

In some embodiments, the another virtual character includes at least two split characters corresponding to the opponent virtual character, and the at least two split characters each have a repelling skill; and

the control module 920 is configured to control, in response to the character control operation on the first virtual character, the first virtual character to be moved to a first position, where the first position is a position at which the first virtual character is repelled from the first position to a center of the combat area after the at least two split characters separately cast the repelling skill.

In some embodiments, the another virtual character includes an opponent virtual character; and

the control module 920 is configured to control, in response to the character control operation on the first virtual character, the first virtual character to be moved to the mobile platform, so that the first virtual character is moved with the mobile platform to a position at which the opponent virtual character is located, to interact with the opponent virtual character.

In some embodiments, the control module 920 is configured to control, in response to a permission obtaining operation, the first virtual character to obtain a control permission for the mobile platform.

In some embodiments, the control module 920 is configured to control, in response to the first virtual character approaching a first non-player character, the first virtual character to obtain a first control permission indicated by the first non-player character, where the first control permission is a permission for controlling the mobile platform to be moved in the first direction; and

the first non-player character is one of at least two non-player characters located in the virtual world, and the at least two non-player characters are in one-to-one correspondence with at least two directions.

In some embodiments, the control module 920 is configured to:

control, in response to a marked point corresponding to an expected movement position of the mobile platform being not in an occupied state, the mobile platform to be moved to the expected movement position; and

unmark a marked point corresponding to a position of the mobile platform before movement as being in the occupied state, and mark the marked point corresponding to the expected movement position of the mobile platform as being in the occupied state.

In some embodiments, the control module 920 is configured to:

control, in response to the first virtual character being not located on the mobile platform, the first virtual character to be moved in the virtual world based on world coordinates of the first virtual character in a world coordinate system, where the world coordinate system is a coordinate system created based on the virtual world; or

control, in response to the first virtual character being located on the mobile platform, the first virtual character to be moved in the virtual world based on relative coordinates of the first virtual character in a relative coordinate system, where the relative coordinate system is a coordinate system created based on the mobile platform on which the first virtual character is currently located.

In some embodiments, the control module 920 is configured to:

obtain the relative coordinates of the first virtual character in the relative coordinate system in response to the first virtual character entering a three-dimensional area corresponding to the mobile platform;

send a check request to a server, where the check request carries the relative coordinates, and the server is configured to check a position of the first virtual character based on the relative coordinates; and

control the first virtual character to be moved in the virtual world based on a check result returned by the server.

For specific limitations in the foregoing embodiments of the one or more virtual world-based interaction apparatuses 900, refer to the foregoing limitations for the virtual world-based interaction method. Details are not described herein again. The modules in the foregoing apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

FIG. 18 is a structural block diagram of a computer device 1000 according to an exemplary embodiment of the present disclosure.

The computer device 1000 may be a portable mobile terminal, or referred to as a mobile terminal in this embodiment, for example, a smartphone, a tablet computer, a moving picture experts group audio layer III (MP3) player, or a moving picture experts group audio layer IV (MP4) player. The computer device 1000 may also be referred to as another name such as a user equipment or a portable terminal.

Generally, the computer device 1000 includes a processor 1001 and a memory 1002.

The processor 1001 may include one or more processing cores. For example, the processor 1001 may be a 4-core processor or an 8-core processor. The processor 1001 may be implemented by using at least one hardware form of a digital signal processor (DSP), a field programmable gate array (FPGA), and a programmable logic array (PLA). The processor 1001 may alternatively include a main processor and a coprocessor. The main processor is configured to process data in an awake state, also referred to as a central processing unit (CPU). The coprocessor is a low-power processor configured to process data in a standby state. In some embodiments, the processor 1001 may be integrated with a graphics processing unit (GPU). The GPU is configured to render and draw content that needs to be displayed on a display screen. In some embodiments, the processor 1001 may further include an artificial intelligence (AI) processor. The AI processor is configured to process computing operations related to machine learning.

The memory 1002 may include one or more computer-readable storage media. The computer-readable storage medium may be tangible and non-transient. The memory 1002 may further include a high-speed random access memory and a non-volatile memory, for example, one or more disk storage devices or flash memory devices. In some embodiments, a non-transitory computer-readable storage medium in the memory 1002 is configured to store at least one instruction, the at least one instruction being configured to be executed by the processor 1001 to implement the virtual world-based interaction method provided in embodiments of the present disclosure.

In some embodiments, the computer device 1000 further exemplarily includes a peripheral interface 1003 and at least one peripheral. Specifically, the peripheral includes: at least one of a radio frequency (RF) circuit 1004, a touch display screen 1005, a camera component 1006, an audio circuit 1007, and a power supply 1008.

A person skilled in the art may understand that the structure shown in FIG. 18 does not constitute any limitation on the computer device 1000, and the computer device may include more components or fewer components than those shown in the figure, or some components may be combined, or a different component deployment may be used.

In an exemplary embodiment, the present disclosure provides a chip, including a programmable logic circuit and/or program instructions, when running on a computer device, the chip being configured to implement the virtual world-based interaction method provided in the foregoing method embodiments.

The present disclosure provides a computer-readable storage medium, having a computer program stored therein, the computer program being loaded and executed by a processor to implement the virtual world-based interaction method provided in the foregoing method embodiments.

The present disclosure provides a computer program product or a computer program, the computer program product or the computer program including computer instructions, the computer instructions being stored in a computer-readable storage medium. A processor of a computer device reads the computer instructions from the computer-readable storage medium and executes the computer instructions to cause the processor of the computer device to perform the virtual world-based interaction method provided in the foregoing method embodiments.

The sequence numbers of the foregoing embodiments of the present disclosure are merely for description purpose but do not imply the preference among the embodiments.

A person of ordinary skill in the art may understand that all or some of the steps of the foregoing embodiments may be implemented by hardware, or may be implemented by a program instructing related hardware. The program may be stored in a computer-readable storage medium. The storage medium may be a ROM, a magnetic disk, or an optical disc.

A person skilled in the art is to be aware that in the one or more examples, the functions described in embodiments of the present disclosure may be implemented using hardware, software, firmware, or any combination thereof. When implemented by using software, the functions can be stored in a computer-readable medium or can be used as one or more instructions or code in a computer-readable medium for transferring. The computer-readable medium includes a computer storage medium and a communication medium, where the communication medium includes any medium that enables a computer program to be transmitted from one place to another. The storage medium may be any available medium accessible to a general-purpose or a dedicated computer.

The foregoing descriptions are merely optional embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A virtual world-based interaction method, performed by a computer device, comprising:
displaying at least two terrain platforms located in a virtual world, the at least two terrain platforms supporting at least two virtual characters, and at least one of the at least two terrain platforms being a mobile platform;
controlling, in response to a movement control operation on the mobile platform, the mobile platform to be moved in the virtual world to change a terrain formed by the at least two terrain platforms; and
controlling, in response to a character control operation on a first virtual character, the first virtual character to interact with other virtual characters of the at least two virtual characters on the terrain formed by the at least two terrain platforms.

2. The method according to claim 1, wherein controlling, in response to the movement control operation on the mobile platform, the mobile platform to be moved in the virtual world comprises:
controlling, in response to a movement control operation of controlling the mobile platform to be moved in a first direction, the mobile platform to be moved in the first direction by at least one grid in the virtual world, wherein the at least one grid is a step unit for movement of the mobile platform, the first direction is one of at least two directions, and the at least two directions comprise at least two of the following directions: east, west, south, north, up, and down.

3. The method according to claim 2, wherein the at least two terrain platforms comprise at least two mobile platforms; and
wherein controlling, in response to the movement control operation of controlling the mobile platform to be moved in the first direction, the mobile platform to be moved in the first direction by at least one grid in the virtual world comprises:
controlling, in response to the movement control operation of controlling the mobile platform to be moved in the first direction, mobile platforms to be moved in the first direction by at least one grid in the virtual world, the mobile platforms being in the at least two mobile platforms and meeting a movement condition, wherein
other mobile platforms remain unchanged in the virtual world, the other mobile platforms being in the at least two mobile platforms and not meeting the movement condition.

4. The method according to claim 3, wherein mobile platforms meeting the movement condition comprise at least one of the following:
at least a first mobile platform, wherein an expected movement position of the mobile platform is not obstructed by a virtual obstacle;
at least a second mobile platform, wherein the expected movement position is not obstructed by another terrain platform;
at least a third mobile platform, wherein the expected movement position is not beyond a boundary line; and
at least a fourth mobile platform not currently in a moving state.

5. The method according to claim 1, further comprising:
displaying, in response to the first virtual character being located on the mobile platform, the first virtual character moved with the mobile platform.

6. The method according to claim 5, wherein the first virtual character is in an immobilized state, wherein no skill is allowed for use in the immobilized state; and
wherein displaying, in response to the first virtual character being located on the mobile platform, the first virtual character moved with the mobile platform comprises:
displaying, in response to the first virtual character being located on the mobile platform, the first virtual character in the immobilized state and moved with the mobile platform.

7. The method according to claim 1, wherein the first virtual character has a buff skill; and
the method further comprises:
displaying, in response to the first virtual character being located on the mobile platform and the first virtual character casting the buff skill, a casting animation of the buff skill moved with the mobile platform.

8. The method according to claim 1, wherein the other virtual characters comprise an opponent virtual character, the opponent virtual character having an opponent skill and being located on the mobile platform; and
the method further comprises:
displaying, in response to the opponent virtual character being located on the mobile platform and the opponent virtual character casting the opponent skill, a casting animation and an attack range of the opponent skill moved with the mobile platform.

9. The method according to claim 1, wherein other virtual characters comprise an opponent virtual character, the opponent virtual character having an opponent skill and being located on the mobile platform; and
wherein controlling, in response to the character control operation on the first virtual character, the first virtual character to interact with other virtual characters in the at least two virtual characters on the terrain formed by the at least two terrain platforms comprises:
controlling, in response to the character control operation on the first virtual character, the first virtual character to be moved in an opposite direction of a movement direction corresponding to the mobile platform so that the first virtual character is moved away from an attack range of the opponent skill.

10. The method according to claim 1, wherein other virtual characters comprise a teammate virtual character, the first virtual character is hit by an opponent skill and is located on a fixed platform, the opponent skill being configured for causing the fixed platform in a debuff skill state, and the debuff skill state spreads to an adjacent terrain platform; and
wherein controlling, in response to the character control operation on the first virtual character, the first virtual character to interact with other virtual characters in the at least two virtual characters on the terrain formed by the at least two terrain platforms comprises:
controlling, in response to the character control operation on the first virtual character, the first virtual character to be moved to the mobile platform so that the first virtual character is moved with the mobile platform to be away from a combat area, wherein the teammate virtual character is located.

11. The method according to claim 1, wherein other virtual characters comprise an opponent virtual character, the opponent virtual character having an opponent skill, the opponent skill having a skill cracking position; and
wherein controlling, in response to the character control operation on a first virtual character, the first virtual character to interact with other virtual characters in the at least two virtual characters on the terrain formed by the at least two terrain platforms comprises:
controlling, in response to the character control operation on the first virtual character, the first virtual character to be moved to the mobile platform so that the first virtual character is moved with the mobile platform to the skill cracking position.

12. The method according to claim 1, wherein other virtual characters comprise at least two split characters corresponding to an opponent virtual character, and the at least two split characters each has a repelling skill; and
wherein controlling, in response to the character control operation on a first virtual character, the first virtual character to interact with other virtual characters in the at least two virtual characters on the terrain formed by the at least two terrain platforms comprises:
controlling, in response to the character control operation on the first virtual character, the first virtual character to be moved to a first position, wherein after the at least two split characters separately cast the repelling skill, the first virtual character is repelled from the first position to a center of a combat area.

13. The method according to claim 1, wherein other virtual characters comprise an opponent virtual character; and
wherein controlling, in response to the character control operation on a first virtual character, the first virtual character to interact with other virtual characters in the at least two virtual characters on the terrain formed by the at least two terrain platforms comprises:
controlling, in response to the character control operation on the first virtual character, the first virtual character to be moved to the mobile platform so that the first virtual character is moved with the mobile platform to a position, wherein the opponent virtual character is located at the position and interact with the first virtual character.

14. The method according to claim 1, wherein before controlling, in response to the movement control operation on the mobile platform, the mobile platform to be moved in the virtual world to change the terrain formed by the at least two terrain platforms, the method further comprises:
controlling, in response to a permission obtaining operation, the first virtual character to obtain a control permission for the mobile platform.

15. The method according to claim 14, wherein controlling, in response to the permission obtaining operation, the first virtual character to obtain the control permission for the mobile platform comprises:
controlling, in response to the first virtual character approaching a first non-player character, the first virtual character to obtain a first control permission indicated by the first non-player character, wherein the first control permission is a permission for controlling the mobile platform to be moved in a first direction.

16. The method according to claim 1, wherein controlling, in response to the movement control operation on the mobile platform, the mobile platform to be moved in the virtual world comprises:
controlling, in response to a marked point corresponding to an expected movement position of the mobile platform being not in an occupied state, the mobile platform to be moved to the expected movement position; and
unmarking a marked point corresponding to a position of the mobile platform before movement as being in the occupied state, and marking the marked point corresponding to the expected movement position of the mobile platform as being in the occupied state.

17. The method according to claim 1, further comprising:
controlling, in response to the first virtual character being not located on the mobile platform, the first virtual character to be moved in the virtual world based on world coordinates of the first virtual character in a world coordinate system, wherein the world coordinate system is a coordinate system created based on the virtual world; or
controlling, in response to the first virtual character being located on the mobile platform, the first virtual character to be moved in the virtual world based on relative coordinates of the first virtual character in a relative coordinate system, wherein the relative coordinate system is a coordinate system created based on the mobile platform.

18. The method according to claim 17, further comprising:
obtaining the relative coordinates of the first virtual character in the relative coordinate system in response to the first virtual character entering a three-dimensional area corresponding to the mobile platform;
sending a check request to a server, wherein the check request carries the relative coordinates, and the server is configured to check a position of the first virtual character based on the relative coordinates; and
controlling the first virtual character to be moved in the virtual world based on a check result returned by the server.

19. A virtual world-based interaction apparatus, comprising a memory for storing instructions and a processor for executing the instructions to:
display at least two terrain platforms located in a virtual world, the at least two terrain platforms supporting at least two virtual characters, and at least one of the at least two terrain platforms being a mobile platform;
control, in response to a movement control operation on the mobile platform, the mobile platform to be moved in the virtual world to change a terrain formed by the at least two terrain platforms; and
control, in response to a character control operation on a first virtual character, the first virtual character to interact with other virtual characters in the at least two virtual characters on the terrain formed by the at least two terrain platforms.

20. A non-transitory computer readable medium storing a plurality of instructions, wherein the plurality of instructions, when executed by a processor, configure the processor to:
display at least two terrain platforms located in a virtual world, the at least two terrain platforms supporting at least two virtual characters, and at least one of the at least two terrain platforms being a mobile platform;
control, in response to a movement control operation on the mobile platform, the mobile platform to be moved in the virtual world to change a terrain formed by the at least two terrain platforms; and
control, in response to a character control operation on a first virtual character, the first virtual character to interact with other virtual characters in the at least two virtual characters on the terrain formed by the at least two terrain platforms.
